(19) United States
(12) Patent Application Publication
(10) Pub. No.: US 2014/0169782 A1
(43) Pub. Date: Jun. 19, 2014

(54) NETWORK DESIGN APPARATUS AND NETWORK DESIGN METHOD

(71) Applicant: Fujitsu Limited, Kawasaki-shi (JP)

(72) Inventors: Tomohiro HASHIGUCHI, Inagi (JP); KAZUYUKI TAJIMA, Yokosuka (JP); Yutaka TAKITA, Kawasaki (JP)

(73) Assignee: Fujitsu Limited, Kawasaki-shi (JP)

(21) Appl. No.: 14/018,059

(22) Filed: Sep. 4, 2013

(30) Foreign Application Priority Data
Dec. 13, 2012 (JP) 2012-272784

(51) Int. Cl. H04B 10/032

(52) U.S. Cl. CPC H04B 10/032
USPC 398/5

(57) ABSTRACT

A network design apparatus includes: a first processing unit configured to select one or more paths between nodes in response to a request for a bandwidth between pairs of nodes in a network to determine working communication routes and protecting communication routes connecting the pairs of nodes, and estimate a number of communication lines in the selected path; and a second processing unit configured to allocate logical channels of the communication lines to the working communication routes and the protecting communication routes based on the requested bandwidth, wherein the first processing unit determines the protecting communication routes while permitting the sharing of the path, and the second processing unit allocates a common logical channel to one or more communication routes, out of the protecting communication routes, that share the path and are not simultaneously used when a failure occurs in the working communication routes.

### CROSS-REFERENCE TO RELATED APPLICATION

This application is based upon and claims the benefit of priority of the prior Japanese Patent Application No. 2012-272784, filed on Dec. 13, 2012, the entire contents of which are incorporated herein by reference.

### FIELD

A certain aspect of embodiments described herein relates to a network design apparatus and a network design method.

### BACKGROUND

A high-speed optical transmission method has been standardized because of increase of telecommunications demand. For example, ITU-T (International Telecommunication Union Telecommunication Standardization Sector) Recommendation G.709 defines technology for an Optical Transport Network (OTN) of approximately 2.5 to 100 (Gbps).

The OTN multiplexes optical signals, each accommodating a user signal, with Wavelength Division Multiplexing (WDM) technology to achieve optical transmission, and enables high-capacity transmission. Examples of the user signal accommodated in the optical signal include an SDH (Synchronous Digital Hierarchy) frame, a SONET (Synchronous Optical NET) frame, and an Ethernet (registered trademark) frame.

On the other hand, the IETF (Internet Engineering Task Force) is considering expansion of GMPLS (Generalized Multi-Protocol Label Switching) signaling technology in order to apply it to the aforementioned OTN. A “Shared mesh restoration” method (hereinafter, described as an SMR method) is an exemplary fault recovery system of the OTN using GMPLS.

The SMR method allows protecting traffic flows that protect working traffic flows, which do not share network resources (i.e. transmission lines and transmission devices) and in which a failure due to the same reason does not occur, to share the network resources. Therefore, desired is a method of designing a network that supports the SMR method in order to construct an economical network. The conventional technology to design an optical network is disclosed in, for example, Japanese Patent Application Publication Nos. 2007-311900, 2004-80666, 11-215124, 10-224393, and 2011-10188.

### SUMMARY

According to an aspect of the present invention, there is provided a network design apparatus including: a first processing unit configured to select one or more paths in response to a request for a bandwidth to determine working communication routes and protecting communication routes connecting pairs of nodes in a network, and estimate a number of communication lines established in each of the one or more paths selected, the one or more paths being configured between nodes in the network, the bandwidth being to be used for communications between the pairs of nodes; and a second processing unit configured to allocate logical channels to the working communication routes and the protecting communication routes based on the requested bandwidth, the logical channels being included in each of the communication lines, wherein the first processing unit determines the protecting communication routes while permitting the protecting communication routes to share the one or more paths, and the second processing unit allocates a common logical channel out of the logical channels to one or more communication routes out of the protecting communication routes, the one or more communication routes sharing the one or more paths and being not simultaneously used when a failure occurs in at least one of the working communication routes.

According to another aspect of the present invention, there is provided a network design method executed by a computer, the network design method including: selecting one or more paths in response to a request for a bandwidth to determine working communication routes and protecting communication routes connecting pairs of nodes in a network; the one or more paths being configured between nodes in the network, the bandwidth being to be used for communications between the pairs of nodes; estimating the number of communication lines established in each of the one or more paths selected; and allocating logical channels to the working communication routes and the protecting communication routes based on the requested bandwidth, the logical channels being included in each of the communication lines, wherein the estimating of the number of the communication lines includes determining the protecting communication routes while permitting the protecting communication routes to share the one or more paths; the allocating of the logical channels includes allocating a common logical channel out of the logical channels to one or more communication routes out of the protecting communication routes, the one or more communication routes sharing the one or more paths and being not simultaneously used when a failure occurs in at least one of the working communication routes.

According to another aspect of the present invention, there is provided a computer readable storage medium storing a network design program causing a computer to execute a process, the process including: selecting one or more paths in response to a request for a bandwidth to determine working communication routes and protecting communication routes connecting pairs of nodes in a network; the one or more paths being configured between nodes in the network, the bandwidth being to be used for communications between the pairs of nodes; estimating the number of communication lines established in each of the one or more paths selected; and allocating logical channels to the working communication routes and the protecting communication routes based on the requested bandwidth, the logical channels being included in each of the communication lines, wherein the estimating of the number of the communication lines includes determining the protecting communication routes while permitting the protecting communication routes to share the one or more paths; the allocating of the logical channels includes allocating a common logical channel out of the logical channels to one or more communication routes out of the protecting communication routes, the one or more communication routes sharing the one or more paths and being not simultaneously used when a failure occurs in at least one of the working communication routes.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a configuration diagram illustrating a network;

FIG. 2 is a configuration diagram illustrating a structure of an optical signal;

FIG. 3 is a configuration diagram illustrating a network design apparatus in accordance with an embodiment;

FIG. 4 is a configuration diagram illustrating functional blocks of a CPU (Central Processing Unit) and information stored in an HDD (Hard Disk Drive);

FIG. 5 is a flowchart illustrating a process by the CPU;

FIG. 6 is a flowchart illustrating a first designing process executed by a first processing unit;

FIG. 7 is a diagram illustrating paths in a network;

FIG. 8 is a diagram illustrating communication route candidates including the paths illustrated in FIG. 7;

FIG. 9 is a diagram illustrating HO-ODUs established in the paths;

FIG. 10 is a table presenting contents of sets used in a model of an integer programming problem built by the first processing unit;

FIG. 11 is a table presenting details of variables used in the model of the integer programming problem built by the first processing unit;

FIG. 12 is a table presenting details of parameters used in the model of the integer programming problem built by the first processing unit;

FIG. 13 is a diagram illustrating allocation of TSs included in the HO-ODUs illustrated in FIG. 9;

FIG. 14 is a flowchart illustrating a second designing process executed by a second processing unit;

FIG. 15 is a diagram illustrating working communication routes and protecting communication routes in a network;

FIG. 16 is a table presenting a comparative example of allocation of TSs to the protecting communication routes illustrated in FIG. 15;

FIG. 17 is a table presenting the working communication routes in which a failure is caused by the link failures in the network illustrated in FIG. 15;

FIG. 18 is a table illustrating allocation of TSs to the protecting communication routes illustrated in FIG. 15;

FIG. 19 is a table presenting contents of sets used in a model of an integer programming problem built by the second processing unit;

FIG. 20 is a table presenting details of variables used in the model of the integer programming problem built by the second processing unit;

FIG. 21 is a table presenting details of parameters used in the model of the integer programming problem built by the second processing unit;

FIG. 22 is a diagram illustrating demands to a network;

FIG. 23 is a diagram illustrating working and protecting communication routes in the network illustrated in FIG. 22;

FIG. 24 is a table presenting the working communication routes in which a failure is caused by the link failures illustrated in FIG. 23;

FIG. 25 is a table presenting allocation of TSs to the protecting communication routes illustrated in FIG. 23;

FIG. 26 is a diagram illustrating alternative examples of demands to a network;

FIG. 27 is a diagram illustrating working and protecting communication routes in the network illustrated in FIG. 26;

FIG. 28 is a table presenting the working communication routes in which a failure is caused by the link failures illustrated in FIG. 27; and

FIG. 29 is a table illustrating allocation of TSs to the protecting communication routes illustrated in FIG. 27.

### DESCRIPTION OF EMBODIMENTS

When the SMR method is employed, network resources may be dynamically allocated to a protecting traffic flow or statically allocated in advance. The dynamic allocation requires complex control at the time of switching from a working path to a protecting path, and thus takes more time than the static allocation. Therefore, the static allocation is more desirable than the dynamic allocation to recover a fault rapidly.

The static allocation of the network resources is performed by, for example, allocating logical channels included in a protecting optical signal in order to efficiently operate the network resources. For example, in a case of the OTN, an HO-ODU (Higher Order Optical channel Data Unit), which is a data format of an optical signal, has fields corresponding to logical channels referred to as a “Tributary Slot (TS)”. The TS accommodates an LO-ODU (Lower Order ODU) accommodating a user signal.

Thus, protecting traffic flows are preferably allocated to the aforementioned TSs to design a network capable of achieving the SMR method in the OTN. However, large-scale and complex problems are to be analyzed in network design taking into account both the HO-ODU (optical signal) and the TS (logical channel), and thus it is difficult to complete the network design within a realistic time period. This problem is not limited to the OTN, and applies to designing of other networks.

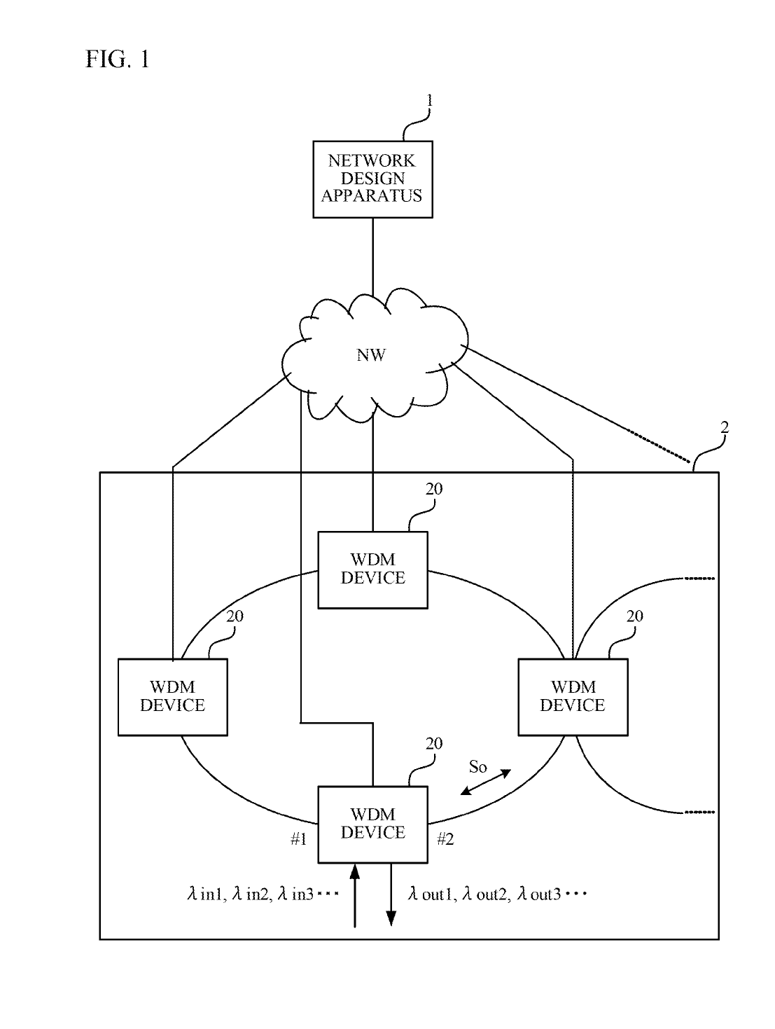

FIG. 1 is a configuration diagram illustrating a network. A network design apparatus 1 is coupled to WDM devices 20 through a monitoring control network NW such as a LAN (Local Area Network). The network design apparatus 1 may double as a network management apparatus such as an NMS (Network Management System).

The WDM device 20 is an optical add-drop multiplexer referred to as a ROADM (Reconfigurable Optical Add-Drop Multiplexer) or the like. The WDM devices 20 are interconnected by optical fibers, and form, for example, a ring type network 2. The network 2 is not limited to a ring type network illustrated in FIG. 1, and may be a mesh type network for example. The network design apparatus 1 designs the network 2 of the WDM devices 20.

The WDM device 20 receives optical signals of desired wavelengths λin1, λin2, λin3, . . . , wavelength-multiplexes the optical signals, and transmits them to another WDM device 20 as a wavelength-multiplexed optical signal So. In addition, the WDM device 20 demultiplexes the wavelength-multiplexed optical signal So transmitted from another WDM device 20 into optical signals of desired wavelengths λout1, λout2, λout3, . . . , and outputs them. The input of the optical signals λin1, λin2, λin3, . . . from the outside to the WDM device 20 is referred to as “add”, and the output of the optical signals λout1, λout2, λout3, . . . from the WDM device 20 to the outside is referred to as “drop”.

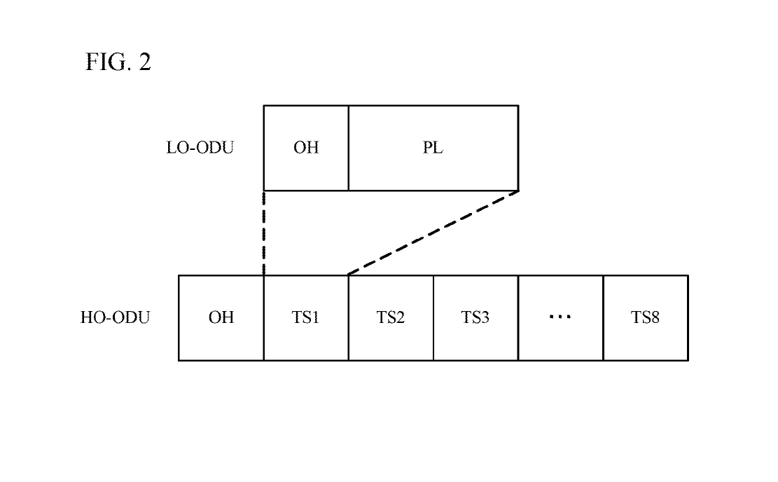

FIG. 2 is a configuration diagram illustrating a structure of an optical signal. The optical signal has an HO-ODU frame defined in ITU-T Recommendation G.709 for example. The HO-ODU includes an overhead OH including predetermined control information and TS1 to TS8 that are logical channels (Tributary Slots). The number of TSs varies in accordance with a transmission rate (i.e. bandwidth) of the HO-ODU, and is eight (TS1 to TS8) in a case of 10 (Gbps) and two in a case of 2.5 (Gbps). TS1 to TS8 have bandwidths of 1.25 (Gbps).

Each of TS1 to TS8 accommodates an LO-ODU. The LO-ODU includes an overhead OH including predetermined control information and a payload PL. The payload PL accommodates a user signal such as an SDH frame, a SONET frame, or an Ethernet frame. Therefore, the HO-ODU can accommodate two or more user signals by multiplexing two or more LO-ODUs. The present specification uses the OTN defined in ITU-T Recommendation G.709 as an example, but does not intend to suggest any limitation.

The network design apparatus 1 establishes communication lines for transmitting/receiving the HO-ODU along paths configured in the network 2 in response to a request for a traffic flow, and allocates logical channels (i.e. TSs) of the HO-ODU to each requested traffic flow. This enables to transmit an optical signal between the WDM devices 20 so as to satisfy the request for the traffic flow. The description hereinafter describes a communication path through which an optical signal of a predetermined wavelength is transmitted from when added to the WDM device 20 till dropped from another WDM device 20 as a “path”. Moreover, a communication line for transmitting/receiving the HO-ODU is simply described as an “HO-ODU”.

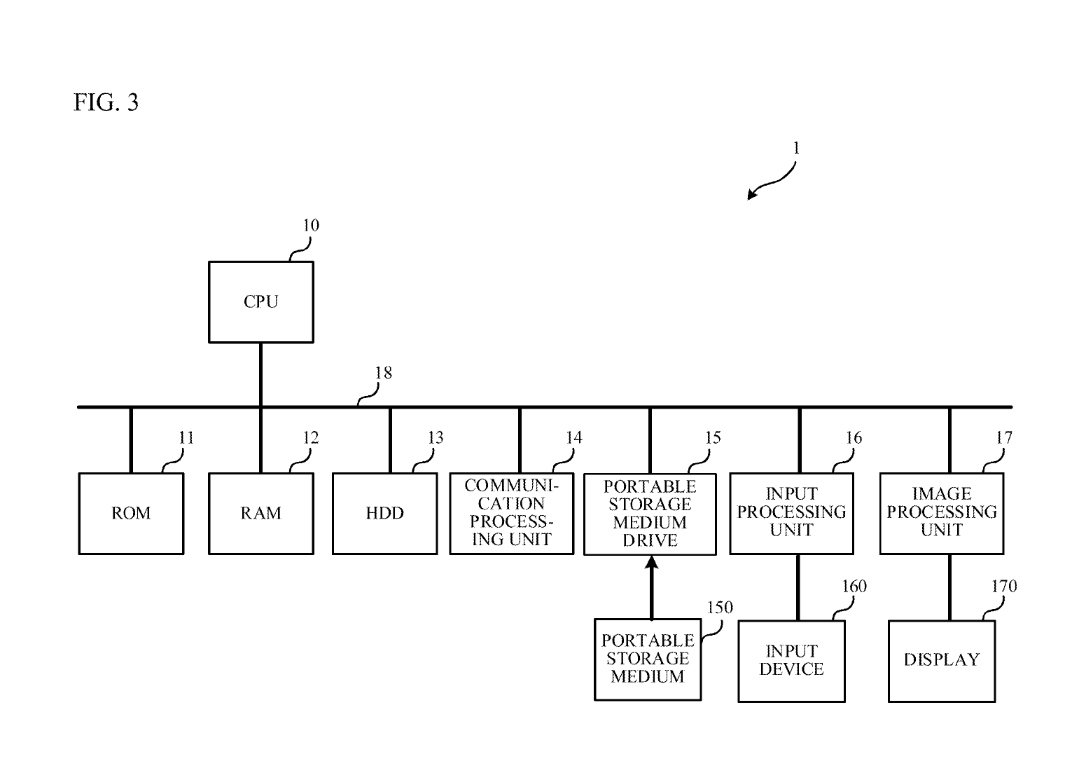

FIG. 3 illustrates a structure of the network design apparatus 1. The network design apparatus 1 is, for example, a computer device such as a server. The network design apparatus 1 includes a CPU 10, a ROM (Read Only Memory) 11, a RAM (Random Access Memory) 12, an HDD 13, a communication processing unit 14, a portable storage medium drive 15, an input processing unit 16, and an image processing unit 17.

The CPU 10 is an arithmetic processing unit, and performs a process of designing the network 2 in accordance with a network design program. The CPU 10 is coupled to components 11 to 17 through a bus 18 so as to communicate with them. The network design apparatus 1 is not limited to a unit that operates by software, and may use a hardware device such as an application specific integrated circuit instead of the CPU 10.

The RAM 12 is used as a working memory of the CPU 10. In addition, the ROM 11 and the HDD 13 are used as storage units to store a network design program that operates the CPU 10. The communication processing unit 14 is a communication unit such as a network card that communicates with an external device through a network such as a LAN. In the configuration illustrated in FIG. 1, the communication processing unit 14 processes the communication with the WDM devices 20 through the monitoring control network NW.

The portable storage medium drive 15 reads/writes information from/to a portable storage medium 150. Examples of the storage medium 150 include a USB (Universal Serial Bus) memory, a CD-R (Compact Disc Recordable), and a memory card.

The network design apparatus 1 further includes an input device 160 through which a user inputs information and a display 170 to display an image. The input device 160 is a device such as a keyboard and a mouse, and input information is output to the CPU 10 through the input processing unit 16. The display 170 is a display unit such as a liquid crystal display to display an image, and image data to be displayed is output from the CPU 10 to the display through the image processing unit 17. Instead of the input device 160 and the display 170, a device such as a touch panel having their functions may be used.

The CPU 10 executes a program stored in the ROM 11 or the HDD 13 or a program read from the portable storage medium 150 by the portable storage medium drive 15. The program includes not only an OS (Operating System) but also the aforementioned network design program. The program may be downloaded through the communication processing unit 14.

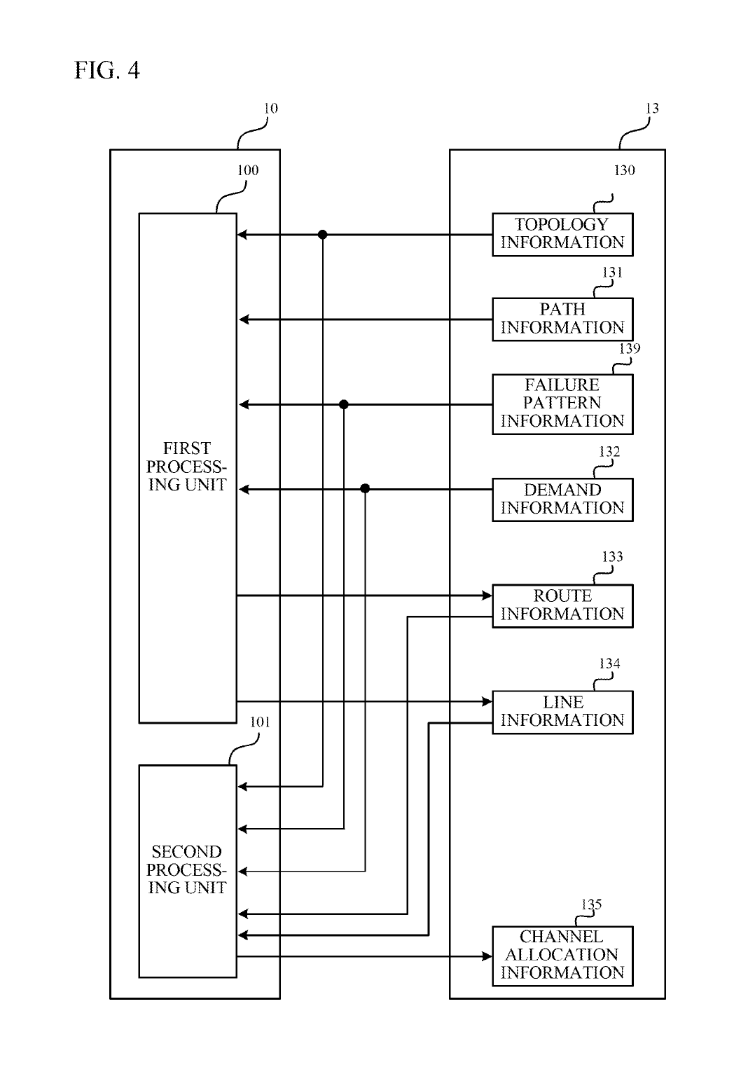

Execution of the network design program by the CPU 10 implements multiple functions. FIG. 4 is a configuration diagram illustrating functional blocks of the CPU 10 and information stored in the HDD 13.

The CPU 10 includes a first processing unit 100 and a second processing unit 101. The HDD 13 stores topology information 130, path information 131, failure pattern information 139, demand information 132, route information 133, line information 134, and channel allocation information 135, which relate to the first processing unit 100 and the second processing unit 101. A storage unit to store the information 130 to 135 is not limited to the HDD 13, and may be the ROM 11 or the portable storage medium 150.

The topology information 130 is information indicating a shape of the network 2 to be designed, that is to say, information indicating connection relationships between nodes through links. The topology information 130 associates an identifier of each link in the network 2 with an identifier of a corresponding pair of nodes connected through the link.

The path information 131 is information indicating paths configured in the network 2. The path information 131 includes identifiers of multiple pairs of nodes, each pair of nodes being nodes at both ends of the path, and identifiers of one or more links connecting the nodes at both ends.

The failure pattern information 139 is information indicating supposed occurrence patterns of various types of failures in the network 2 indicated by the topology information 130. The failure includes a single or multiple link failures, or a single or multiple node failures.

The demand information 132 is information indicating a request for multiple traffic flows to the network 2. The demand information 132 indicates a bandwidth used for communications between pairs of nodes in the network with respect to each requested traffic flow. In addition, the demand information 132 includes share availability information that indicates whether different traffic flows are permitted to share a path in the network 2. Each request for a traffic flow is described as a “demand” hereinafter. The topology information 130, the path information 131, and the demand information 132 may be acquired from the outside through the monitoring control network NW, the portable storage medium 150, or the input device 160.

The first processing unit 100 reads the topology information 130, the path information 131, the failure pattern information 139, and the demand information 132 from the HDD 13, and determines working communication routes and protecting communication routes corresponding to a request for multiple traffic flows based on the information 130 to 132. The working communication route and the protecting communication route have a one-to-one correspondence relationship, and when a failure occurs in the working communication route, the protective function of the network 2 switches the communication route so that the traffic flow flows through the protecting communication route instead of the working communication route.

The first processing unit 100 estimates the bandwidths of and the number of the HO-ODUs established in one or more paths included in the determined working communication route and the determined protecting communication route. The first processing unit 100 generates the route information 133 and the line information 134 and writes them to the HDD 13 as a design result, where the route information 133 indicates the determined working communication route and the determined protecting communication route and the line information 134 indicates the bandwidths of and the number of the HO-ODUs estimated for each path.

The second processing unit 101 reads the topology information 130, the failure pattern information 139, the demand information 132, the route information 133, and the line information 134 from the HDD 13, and allocates the TSs of the HO-ODUs to the communication routes based on the information 132 to 134. The second processing unit 101 generates the channel allocation information 135 indicating the allocation results of the TSs, and writes it to the HDD 13.

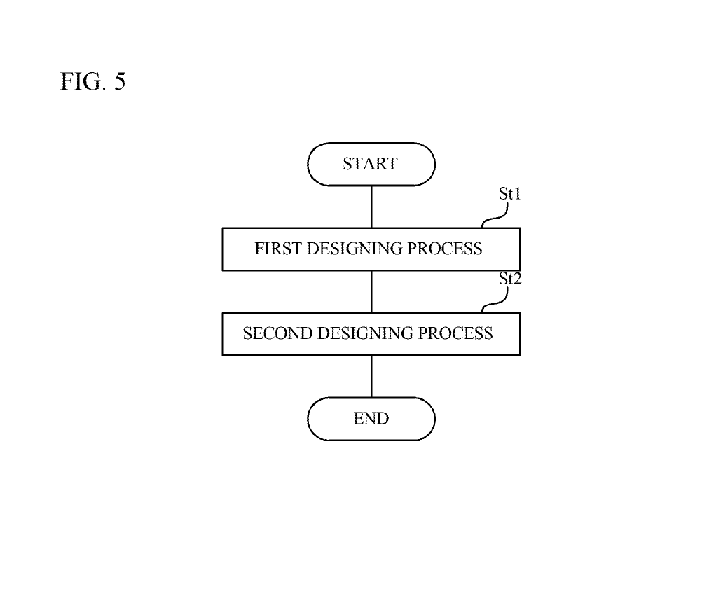

FIG. 5 is a flowchart illustrating a process by the CPU 10. The CPU 10 performs a first designing process by the first processing unit 100 (step St1). This process generates the route information 133 and the line information 134.

The CPU 10 then performs a second designing process by the second processing unit 101 (step St2). This process generates the channel allocation information 135. As described above, the network design apparatus 1 of the embodiment divides the designing process into two stages and executes them to effectively reduce the time required for designing. Hereinafter, the details of the first designing process and the second designing process are described more specifically.

### (First Designing Process)

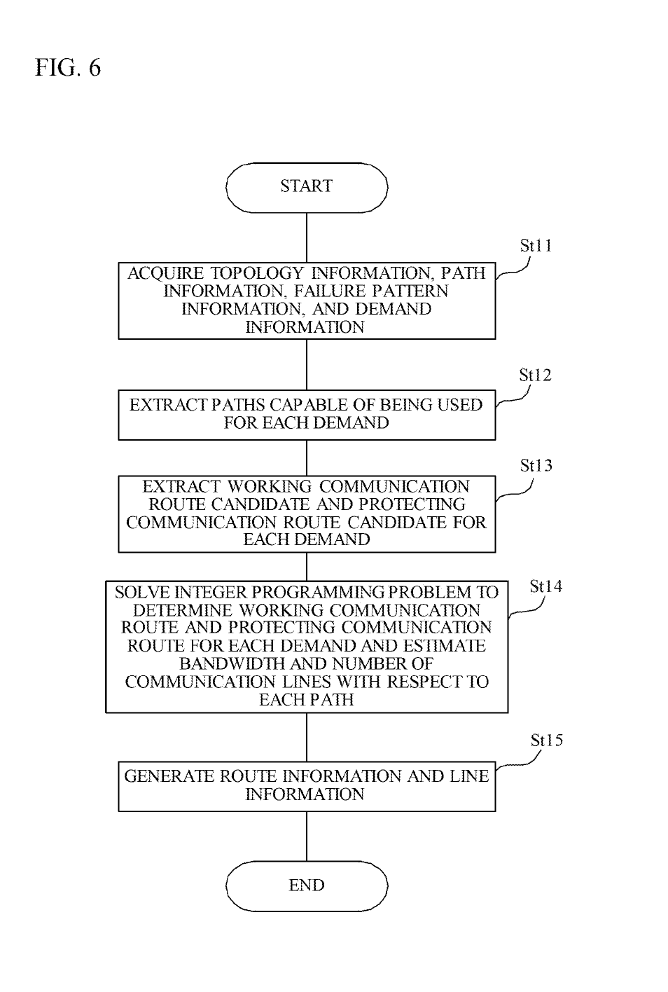

FIG. 6 is a flowchart illustrating the first designing process executed by the first processing unit 100. The first processing unit 100 acquires the topology information 130, the path information 131, the failure pattern information 139, and the demand information 132 from the HDD 13 (step St11).

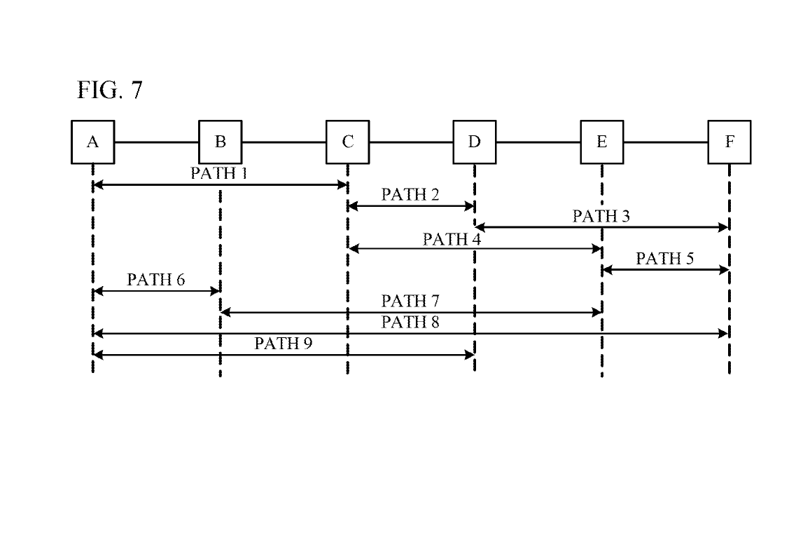

The first processing unit 100 then extracts paths capable of being used for each demand (step St12). FIG. 7 illustrates paths configured in a network. For convenience sake, FIG. 7 illustrates a simple network in which nodes A to F are connected in series. The WDM device 20 is provided in each of the nodes A to F. In the present embodiment, assume that a pair of nodes corresponding to a demand is the node A and the node F. The first processing unit 100 may generate paths at step St12, and in this case, does not need to acquire the path information 131 at step St11.

The first processing unit 100 extracts paths 1 to 9, which are configured between the node A and the node F corresponding to the demand, from one or more paths configured in the network. That is to say, the paths 1 to 9 are extracted as a path that can be at least a part of the communication route connecting the node A and the node F. For example, the path 1 connects the node A and the node C, and the path 2 connects the node C and the node D.

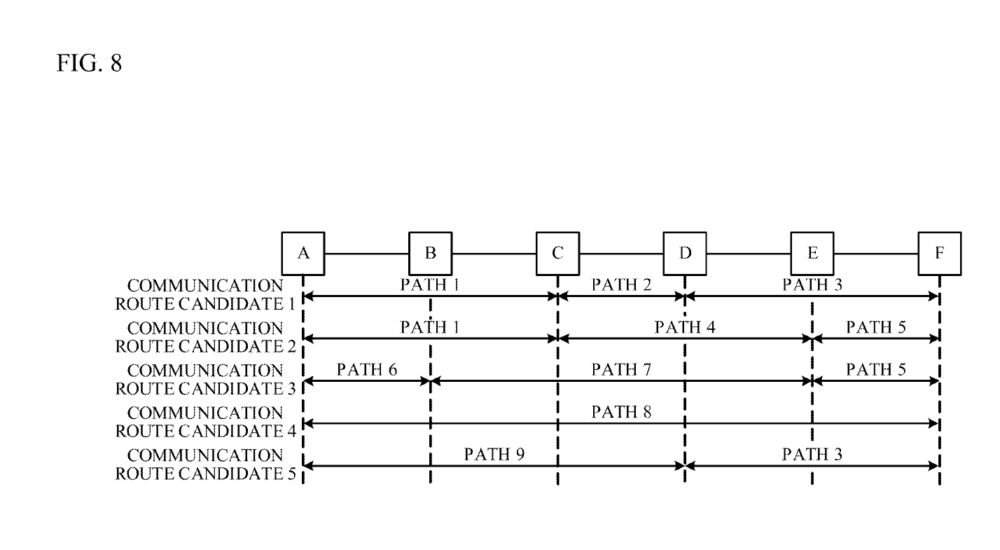

Then, the first processing unit 100 selects one or more paths to extract working communication route candidates and protecting communication route candidates for each demand (step St13). FIG. 8 illustrates communication route candidates including the paths 1 to 9 illustrated in FIG. 7. The communication routes illustrated in FIG. 8 may be any of the working communication route candidates and the protecting communication route candidates.

For example, a communication route candidate 1 includes the path 1, the path 2, and the path 3, and a communication route candidate 2 includes the path 1, the path 4, and the path 5. As described above, the communication route candidates 1 to 5 are extracted as a combination of one or more paths.

The first processing unit 100 then solves an integer programming problem to determine the working communication route and the protecting communication route for each demand, and estimates the bandwidths of and the number of the HO-ODUs for each path (step St14). The model of the integer programming problem built by the first processing unit 100 will be described later.

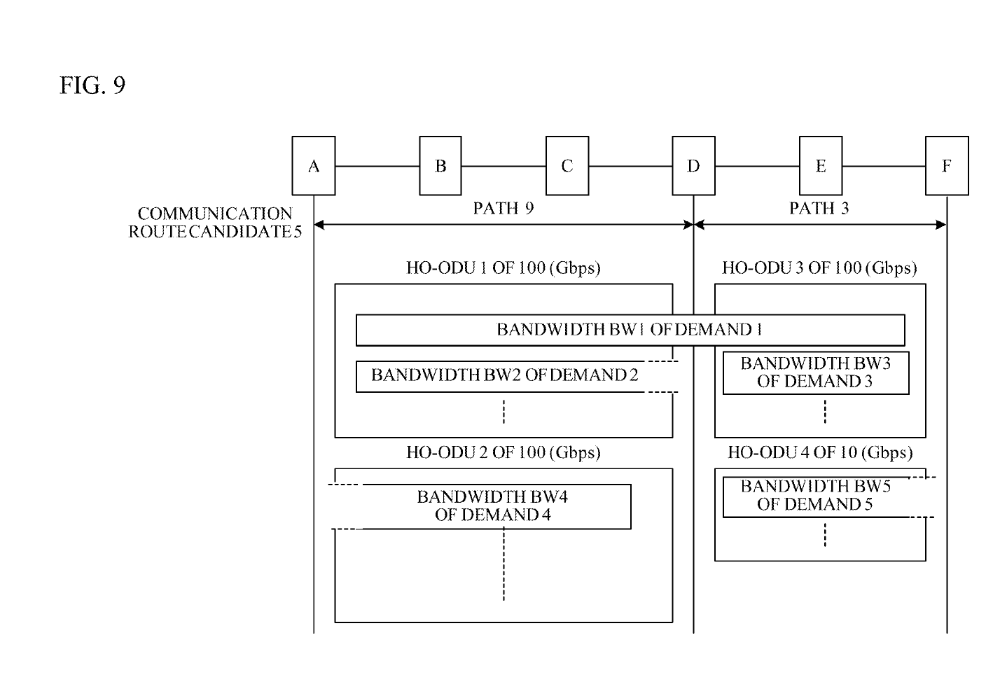

FIG. 9 illustrates the HO-ODUs established in the path. In the present embodiment, the first processing unit 100 selects the candidate 5 as the communication route for the demands from the communication route candidates 1 to 5 illustrated in FIG. 8. The selected communication route includes the path 9 and the path 3.

The first processing unit 100 estimates the number of the HO-ODUs established in each of the path 9 and the path 3. The estimation is performed with respect to each of the bandwidths of the communication lines, i.e. with respect to each of the types of the bandwidths. For example, ITU-T Recommendation G.709 defines “ODU2” of 10 (Gbps), “ODU3” of 40 (Gbps), and “ODU4” of 100 (Gbps) as the type of the bandwidth of the communication line. As described above, flexible designing in accordance with demands of various bandwidths becomes possible by estimating the communication line with respect to each of the bandwidth types.

The first processing unit 100 estimates the number of the HO-ODUs so that the entire cost of the HO-ODUs in the network is minimum. The cost of the HO-ODU is determined by the bandwidth type based on a price and a maintenance expense of a line processing unit mounted on the WDM device 20 for example.

As a consequence of estimation, two HO-ODUs 1, 2 of 100 (Gbps) (“ODU4”) are allocated to the path 9 as communication lines corresponding to the demands. The HO-ODU 1 accommodates a bandwidth BW1 of a demand 1 and a bandwidth BW2 of a demand 2, and the HO-ODU 2 accommodates a bandwidth BW4 of a demand 4. Further, the HO-ODU 3 of 100 (Gbps) (“ODU4”) and the HO-ODU 4 of 10 (Gbps) (“ODU2”) are allocated to the path 3. The HO-ODU 3 accommodates the bandwidth BW1 of the demand 1 and a bandwidth BW3 of a demand 3, and the HO-ODU 4 accommodates a bandwidth BW5 of a demand 5.

The first processing unit 100 permits protecting communication routes to share one or more paths when determining the protecting communication route. Whether to permit sharing of the path is determined according to the share availability information included in the demand information 132 as already described. This allows the first processing unit 100 to permit protecting traffic flows to share the bandwidth of the HO-ODU established in the path. At least two protecting communication routes are permitted to share the bandwidth to achieve the above described SMR method, where the at least two protecting communication routes are not simultaneously used when a failure occurs in the working communication route. Therefore, the first processing unit 100 estimates a maximum value of the protecting shared bandwidths to be needed due to link failures in the network with respect to each of the shared paths, and estimates the bandwidths of and the number of the HO-ODUs according to the maximum value.

The first processing unit 100 then generates the route information 133 and the line information 134 based on the estimation result (step St15). The route information 133 indicates the working communication route and the protecting communication route as a set of one or more paths with respect to each demand. The line information 134 indicates the bandwidths of and the number of the HO-ODUs with respect to each path. The generated route information 133 and the line information 134 are used in the second designing process by the second processing unit 101. The first processing unit 100 performs the first designing process as described above.

A description will now be given of a model of the integer programming problem built by the first processing unit 100 at the process St14 illustrated in FIG. 6. The integer programming problem is a way to calculate the solution that makes a given function value minimum or maximum according to one or more constraint conditions. The model of the integer programming problem is built based on the topology information 130, the path information 131, the failure pattern information 139, and the demand information 132.

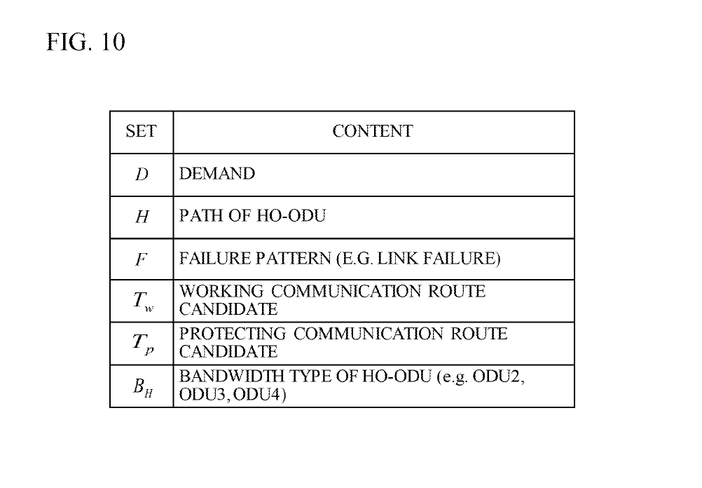

FIG. 10 illustrates contents of sets used in the model of the integer programming problem built by the first processing unit 100. Set D is a set of all demands. Set F is a set of all failure patterns to occur in the network. Examples of failure patterns include a link failure between nodes, that is to say, a failure of a transmission line or a failure of a transceiver of the WDM device 20.

Set H is a set of all paths configured in the network. Each path includes one or more links in the network. Set T_{w} is a set of all working communication route candidates, and set Tₚ is a set of all protecting communication route candidates. Set B_{H} is a set of all bandwidth types of the HO-ODUs (“ODU2”, “ODU3”, “ODU4”, or the like described above).

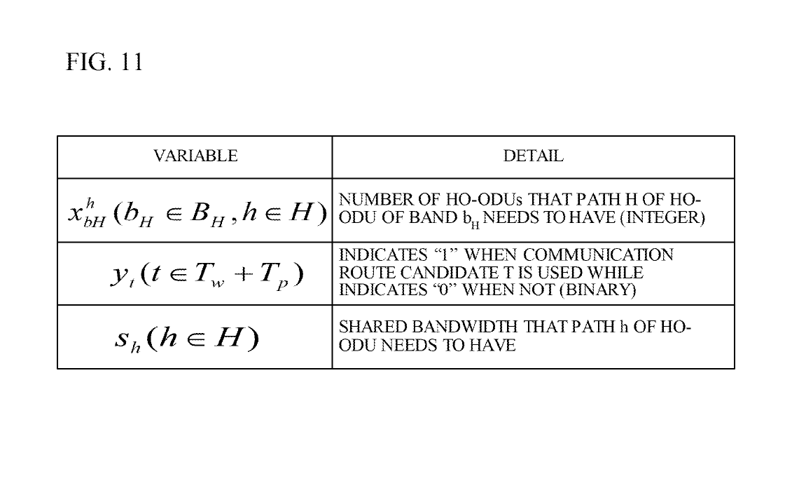

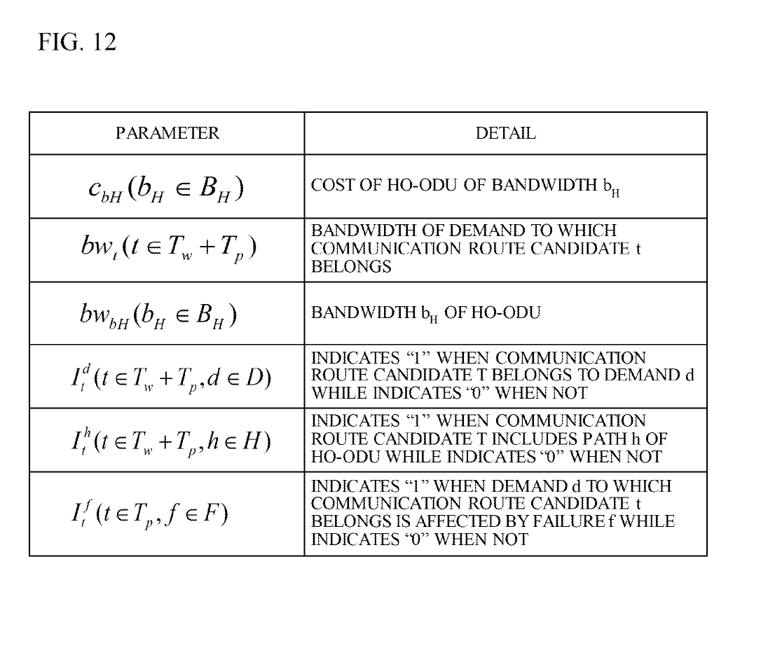

The first processing unit 100 uses, for example, the following equation (1) as an objective function. FIG. 11 and FIG. 12 illustrate details of variables and details of parameters used in the model of the integer programming problem built by the first processing unit 100.

$$Minimize \text{:} {\sum }_{h ∈ H , {b}_{H} ∈ {B}_{H}} {C}_{bH} \cdot {x}_{bH}^{h} \qquad ( 1 )$$

According to the equation (1), the first processing unit 100 estimates the bandwidths of and the number of the HO-ODUs so that the entire cost of the HO-ODUs in the network is minimum. The entire cost of the HO-ODUs is calculated by calculating a product of cost and the number of the HO-ODUs with respect to each bandwidth type and then summing the calculated products.

The first processing unit 100 uses, for example, the following equations (2) to (5) as the constraint conditions.

$$\begin{matrix}{\sum }_{t ∈ Tw} {I}_{t}^{d} \cdot {y}_{t} = 1 ( for ∀ d ∈ D ) & ( 2 ) \\ {\sum }_{t ∈ Tp} {I}_{t}^{d} \cdot {y}_{t} = 1 ( for ∀ d ∈ D ) & ( 3 ) \\ {\sum }_{t ∈ Tw} {I}_{t}^{h} \cdot {bw}_{t} \cdot {y}_{t} + {s}_{h} - {\sum }_{{b}_{H} ∈ {B}_{H}} {bw}_{bH} \cdot {x}_{{b}_{H}}^{h} \leq 0 ( for ∀ h ∈ H ) & ( 4 ) \\ {\sum }_{t ∈ Tp} {I}_{t}^{h} \cdot {I}_{t}^{f} \cdot {bw}_{t} \cdot {y}_{t} - {s}_{h} \leq 0 ( for ∀ h ∈ H , ∀ f ∈ F ) & ( 5 )\end{matrix}$$

The equation (2) and the equation (3) present constraint conditions (first constraint condition) for working communication routes and protecting communication routes to be one working communication route and one protecting communication route respectively, which are selected from communication route candidates obtained by selecting one or more paths, for each demand. That is to say, the first processing unit 100 selects one working communication route and one protecting communication route from the communication route candidates as illustrated in FIG. 8.

The equation (4) present a constraint condition (second constraint condition) for the total bandwidth of the communication lines, with respect to each of one or more path, to be greater than or equal to a value that is obtained by adding the total bandwidth of communication routes including the path out of the working communication routes to the bandwidth shared by the protecting communication routes. That is to say, the first processing unit 100 estimates the bandwidths of and the number of the HO-ODUs so that the HO-ODU established in each path has a bandwidth greater than or equal to a value obtained by adding the total bandwidth of demands, the demands including the path in the communication routes, to the protecting shared bandwidth that the path needs to have as illustrated in FIG. 9.

The equation (5) is a constraint condition (third constraint condition) for the bandwidth shared by the protecting communication routes to be greater than or equal to the total bandwidth of one or more communication routes with respect to each of one or more paths, where the one or more communication routes are included in one or more protecting communication routes, share the path, and are simultaneously used when a failure occurs in any one of the working communication routes. The constraint conditions are satisfied in all the failure patterns F.

Therefore, when a failure pattern is limited to a single link failure, the shared bandwidth sₕ is estimated to be greater than or equal to a maximum value of the bandwidths of the protecting communication routes to be used due to respective link failures in the network. For example, when a protecting shared bandwidth to be used due to a certain link failure is 1 (Gbps) and a protecting shared bandwidth to be used due to another link failure is 2 (Gbps) in a specific path, the shared bandwidth that the path needs to have is estimated to be greater than or equal to 2 (Gbps).

The first processing unit 100 obtains the solution satisfying the equation (1) according to the constraint conditions of the equations (2) to (5) to determine the working communication route and the protecting communication route corresponding to each demand, and estimates the bandwidths of and the number of the HO-ODUs for each path. This effectively reduces the time required for the first designing process. The present embodiment uses the integer programming approach as an analyzing method, but does not intend to suggest any limitation, and may use other methods such as a heuristic method.

### (Second Designing Process)

The second processing unit 101 performs the second designing process based on the topology information 130, the failure pattern information 139, the demand information 132, and the route information 133 and the line information 134 generated by the first processing unit 100. The second processing unit 101 allocates TSs included in each of the HO-ODUs to working communication routes and protecting communication routes indicated by the route information 133 based on the bandwidth of each demand. Each of the HO-ODUs includes as many TSs as correspond to bandwidths (bandwidth types) as described above.

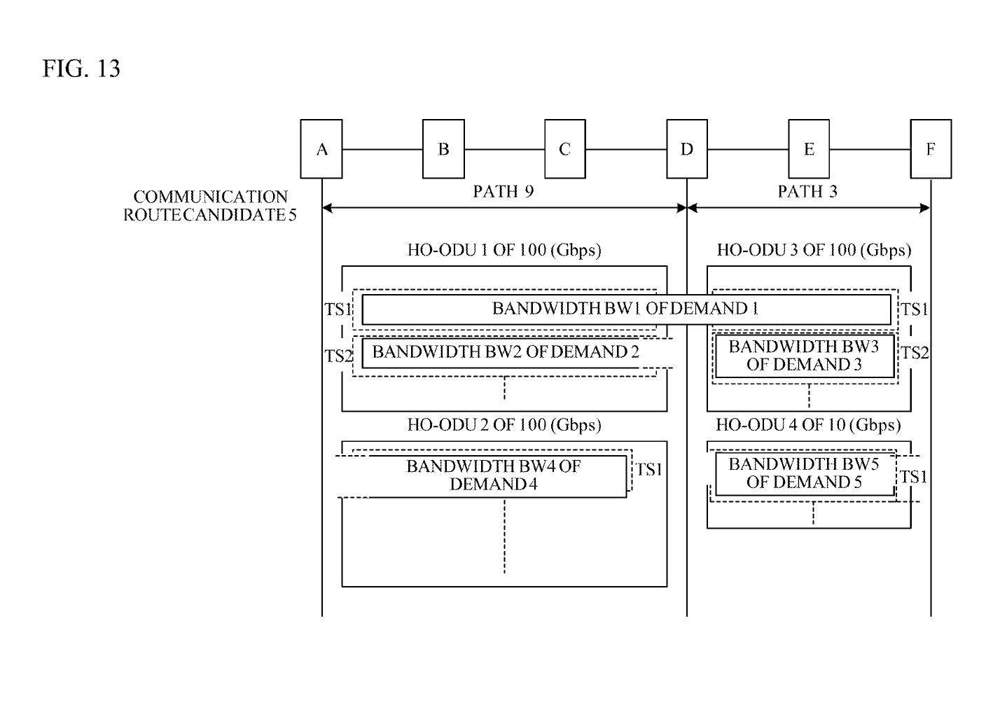

FIG. 13 illustrates allocation of TSs included in the HO-ODUs illustrated in FIG. 9. For example, TS1 of the HO-ODU 1 is allocated to the communication route of the demand 1, and accommodates the bandwidth BW1 of the demand 1. In addition, TS2 of the HO-ODU 1 is allocated to the communication route of the demand 2, and accommodates the bandwidth BW2 of the demand 2. As described above, efficient operation of network resources becomes possible by allocating the HO-ODU to the communication route of each demand in units of TSs.

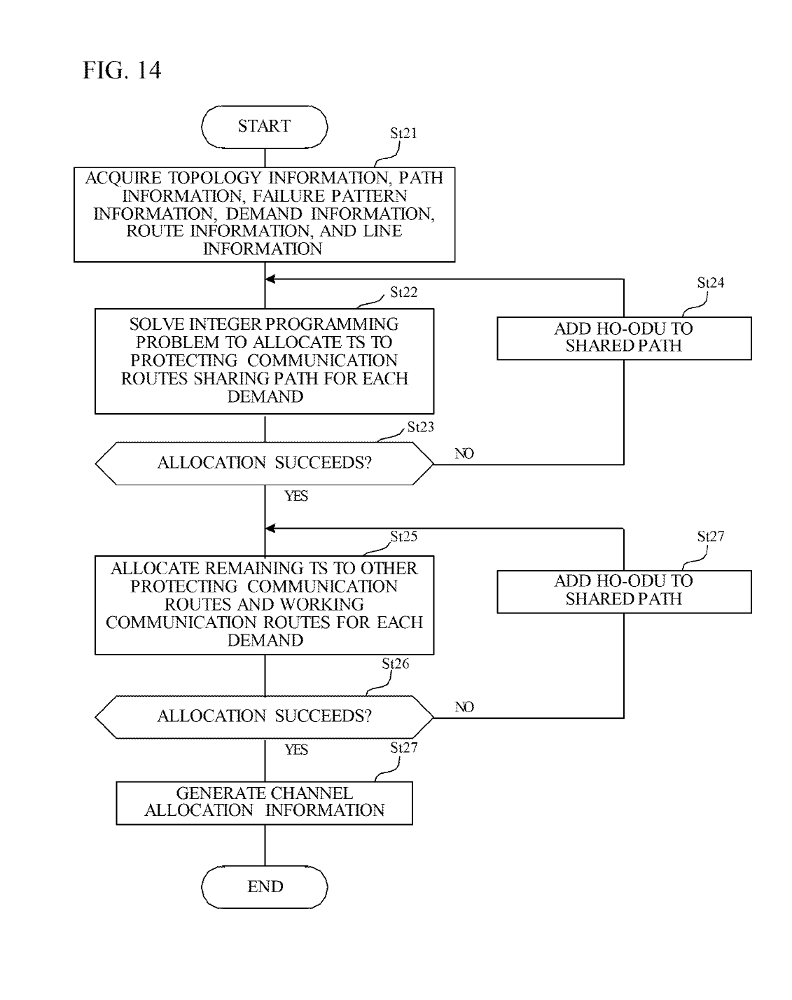

FIG. 14 is a flowchart illustrating the second designing process executed by the second processing unit 101. The second processing unit 101 reads the topology information 130, the failure pattern information 139, the demand information 132, the route information 133, and the line information 134 from the HDD 13 (step St21).

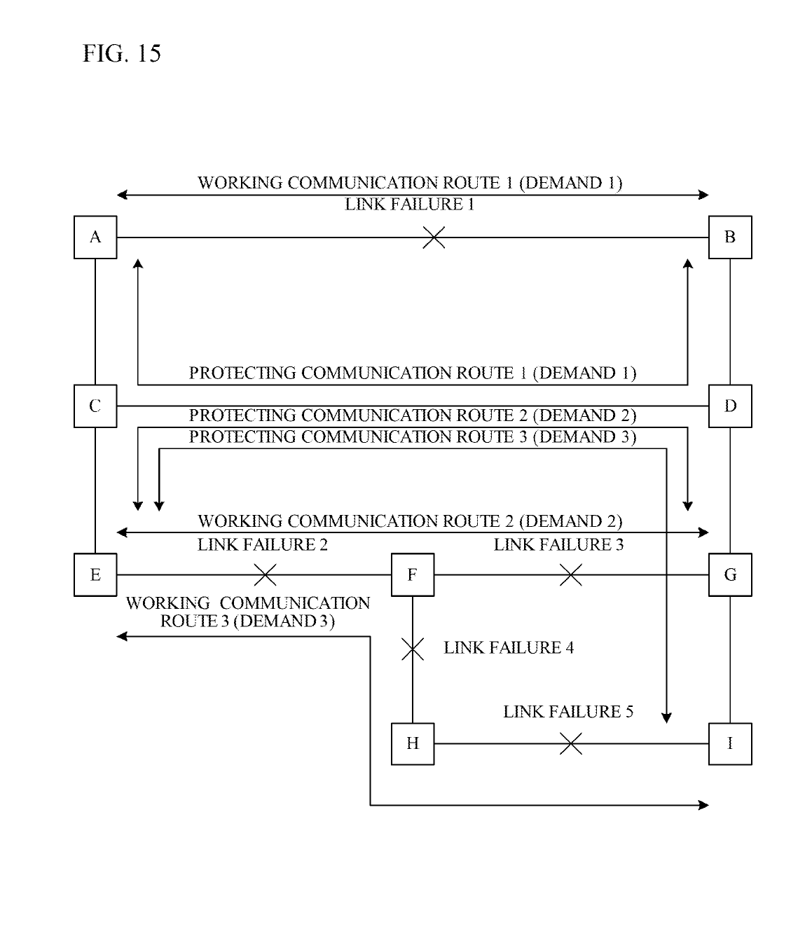

The second processing unit 101 then solves the integer programming problem to allocate TSs of the HO-ODU to the protecting communication routes that share a path (communication routes that are permitted to share the path according to the share availability information included in the demand information 132) for each demand (step St22). The second processing unit 101 allocates a common TS of the TSs to one or more communication routes that are included in the protecting communication routes, share one or more paths, and are not simultaneously used when a failure occurs in any one of the working communication routes. A detailed description will be given hereinafter with reference to FIG. 15 to FIG. 18.

FIG. 15 illustrates working communication routes and protecting communication routes in the network. In the present example, a working communication route 1 of the demand 1 is determined as the path connecting the node A and the node B, and a protecting communication route 1 is determined as the path connecting the node A, the node C, the node D, and the node B. A working communication route 2 of the demand 2 is determined as the path connecting the node E, the node F, and the node G, and a protecting communication route 2 is determined as the path connecting the node E, the node C, the node D, and the node G. A working communication route 3 of the demand 3 is determined as the path connecting the node E, the node F, the node H, and the node I, and a protecting communication route 3 is determined as the path connecting the node E, the node C, the node D, the node G, and the node I.

The protecting communication routes 1 to 3 of the demands 1 to 3 share the path connecting the node C and the node D. Thus, at step St22, the second processing unit 101 allocates the TSs of the HO-ODU established in the path connecting the node C and the node D. In the present embodiment, assume that the bandwidth of the demand 1 is 2.5 (Gbps) (i.e. TS number=2) and the bandwidths of the demands 2 and 3 are 1.25 (Gbps) (i.e. TS number=1).

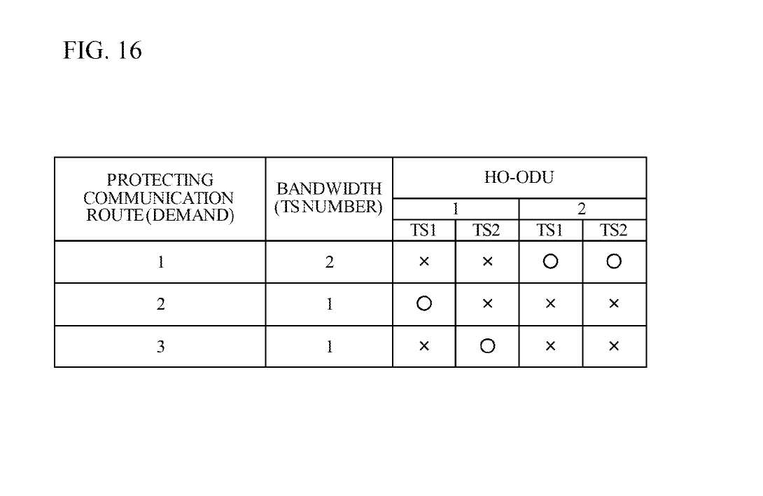

If TSs are allocated to the protecting communication routes 1 to 3 of the demands 1 to 3 without permitting the protecting communication routes 1 to 3 to share a TS, the path connecting the node C and the node D needs the HO-ODU of a bandwidth satisfying the sum of the bandwidths of the demands 1 to 3. FIG. 16 illustrates a comparative example of allocation of TSs to the protecting communication routes illustrated in FIG. 15. In FIG. 16, a communication route to which a TS is allocated is indicated by a circle, and a communication route to which a TS is not allocated is indicated by a cross.

In the present example, two HO-ODUs 1, 2 become necessary to satisfy all the bandwidths of the demands 1 to 3. TS1 and TS2 of the HO-ODU 2 are allocated to the protecting communication route 1 of the demand 1. In addition, TS1 out of TS1 and TS2, which are two logical channels, of the HO-ODU 1 is allocated to the protecting communication route 2 of the demand 2, and TS2 is allocated to the protecting communication route 3 of the demand 3. That is to say, in the present example, individual TSs are allocated to the protecting communication routes 1 to 3 of the demands 1 to 3.

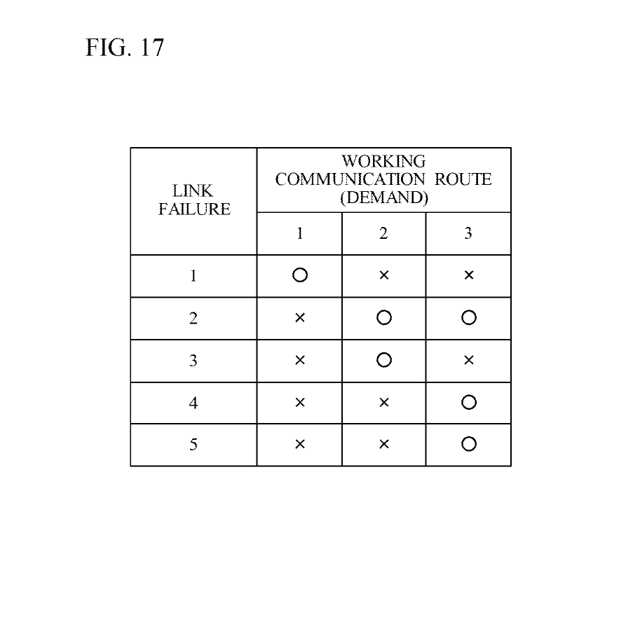

In this condition, the second processing unit 101 allocates the TSs while permitting the protecting communication routes 1 to 3 of the demands 1 to 3 to share a TS in consideration of a failure to occur in the working communication route. FIG. 17 illustrates the working communication routes in which a failure is caused by the link failures in the network illustrated in FIG. 15. Link failures 1 to 5 represent failures of links included in the working communication routes 1 to 3 illustrated in FIG. 15 (see crosses in FIG. 15). Moreover, in FIG. 17, circles represent communication routes in which a failure is caused by a link failure, and crosses represent communication routes in which a failure is not caused by a link failure.

For example, when the link failure 1 occurs, the working communication route 1 of the demand 1 includes the path between the node A and the node B, and thus a failure is caused therein, but other communication routes 2, 3 of the demands 2, 3 do not include the path where the link failure 1 occurs, and thus a failure is not caused therein. Moreover, when the link failure 2 occurs, the working communication routes 2, 3 of the demands 2, 3 include the path between the node E and the node F, and thus a failure is caused therein, but the working communication route 1 of the demand 1 does not include the path where the link failure 2 occurs, and thus a failure is not caused therein. Further, when the link failure 3 occurs, a failure occurs in only the working communication route 2 of the demand 2, and when the link failures 4, 5 occur, a failure occurs in only the working communication route 3 of the demand 3.

Therefore, the same link failure 2 causes a failure in the working communication routes 2, 3 of the demands 2, 3, but does not cause a failure in the working communication route 1 of the demand 1 at the same time. In other words, the protecting communication routes 2, 3 of the demands 2, 3 may be simultaneously used when a failure occurs, but are not simultaneously used together with the protecting communication route 1 of the demand 1. Therefore, the protecting communication routes 2, 3 of the demands 2, 3 can share the bandwidth with the protecting communication route 1 of the demand 1 according to the above described SMR method, and a common TS can be allocated to them.

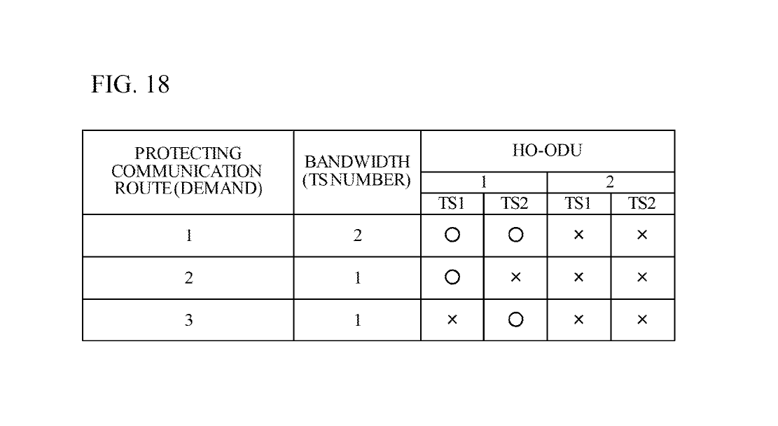

FIG. 18 illustrates allocation of TSs to the protecting communication routes illustrated in FIG. 15. In FIG. 18, a circle indicates a communication route to which a TS is allocated, and a cross indicates a communication route to which a TS is not allocated.

As described above, common TSs can be allocated to the protecting communication route 1 of the demand 1 and the protecting communication routes 2, 3 of the demands 2, 3. Therefore, TS1 and TS2 of the HO-ODU 1 are allocated to the protecting communication route 1 of the demand 1 based on the requested bandwidth (TS number=2). Moreover, TS1 and TS2 of the HO-ODU 1 are allocated to the protecting communication routes 2, 3 of the demands 2, 3 based on the requested bandwidth (TS number=1). This eliminates the use of the HO-ODU 2 unlike the comparative example in FIG. 10, and enables to efficiently use network resources.

Moreover, the TSs are statically allocated to the protecting communication routes 1 to 3 of the demands 1 to 3. In the example of FIG. 16, the protecting communication route 2 of the demand 2 is statically allocated to TS 1, and never allocated to TS2. Further, the protecting communication route 3 of the demand 3 is statically allocated to TS2, and never allocated to TS1. That is to say, the second processing unit 101 does not dynamically allocate logical channels.

The second processing unit 101 solves the integer programming problem described later to allocate the TSs. Back to FIG. 14, the second processing unit 101 determines whether the TSs are successfully allocated (step St23).

When the allocation fails (step St23/NO), i.e. when the number of the TSs allocated to the protecting communication routes sharing a path is insufficient, the second processing unit 101 adds the HO-ODU to the shared path (step St24), and performs allocation again (step St22). This allows the second processing unit 101 to modify the number of the HO-ODUs estimated by the first processing unit 100 and increase the number of TSs, and to allocate the TSs.

On the other hand, when the allocation is successfully performed (step St23/YES), i.e. when the number of the TSs allocated to the protecting communication routes sharing a path is sufficient, the second processing unit 101 allocates remaining TSs, which are not allocated in the process at step St22, to other protecting communication routes (protecting communication routes not permitted to share the path according to the share availability information) and the working communication route (step St25). At this time, the second processing unit 101 allocates the TSs with the same method described with reference to FIG. 16. That is to say, sharing of a TS is not permitted to the communication routes of the demands, and individual TSs are allocated to them. Therefore, the protecting communication routes and the working communication routes that do not share a path do not have a shared bandwidth, and have individual bandwidths.

The second processing unit 101 determines whether the TSs are allocated successfully (step St26). When the allocation fails (step St26/NO), i.e. when the number of the TSs is insufficient, the second processing unit 101 adds the HO-ODU to the shared path (step St27), and performs allocation again (step St25). This allows the second processing unit 101 to modify the number of the HO-ODUs estimated by the first processing unit 100 and increase the number of TSs, and to allocate TSs.

The second processing unit 101 then generates the channel allocation information 135 indicating the allocation of the TSs for each demand. The generated channel allocation information 135 is transmitted to the WDM devices 20 by the communication processing unit 14 in FIG. 3 through the monitoring control network NW. Each of the WDM devices 20 reflects the received channel allocation information 135 to the settings of the own device. The second processing unit 101 performs the second designing process as described above.

A description will now be given of a model of the integer programming problem built by the second processing unit 101 in the process at St22 illustrated in FIG. 14. The model of the integer programming problem is built based on the topology information 130, the failure pattern information 139, the demand information 132, the route information 133, and the line information 134.

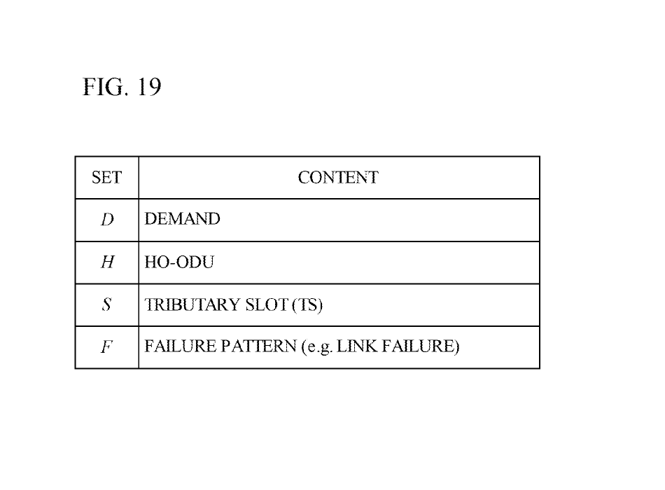

FIG. 19 illustrates contents of sets used in the model of the integer programming problem built by the second processing unit 101. Set D is a set of all demands. Set H is a set of all HO-ODUs included in the line information 134. The second processing unit 101 modifies contents of set H when adding the HO-ODU (steps St24 and St27 described above).

Set S is a set of TSs of all HO-ODUs included in the line information 134. The second processing unit 101 modifies contents of set S when adding the HO-ODU (steps St24 and St27 described above).

Set F is a set of all failure patterns to occur in the network. The failure pattern is a link failure illustrated in FIG. 15 and FIG. 17 for example.

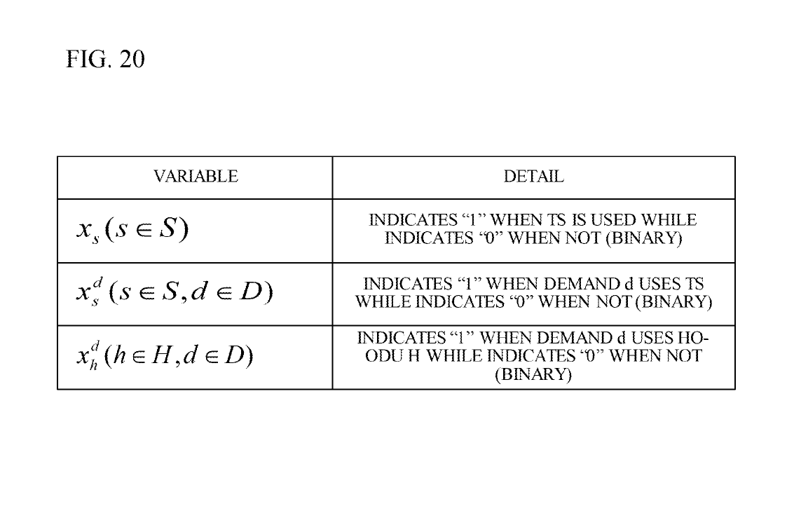

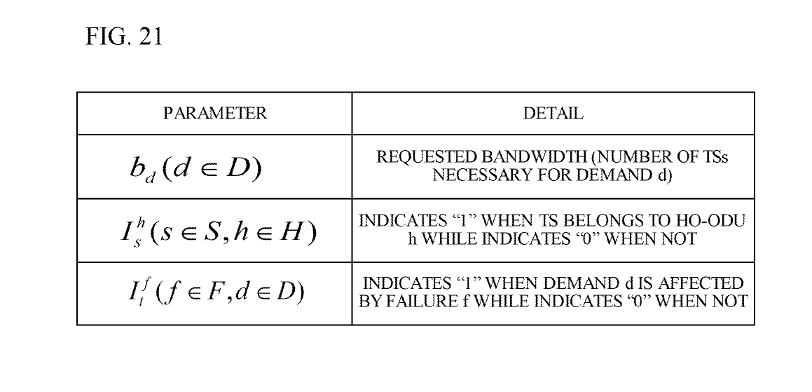

The second processing unit 101 uses, for example, the following equation (6) as an objective function. FIG. 20 and FIG. 21 illustrate details of variables and details of parameters used in the model of the integer programming problem built by the second processing unit 101.

$$Minimize \text{:} {\sum }_{s ∈ S} {x}_{S} \qquad ( 6 )$$

According to the equation (6), the second processing unit 101 allocates TSs to each of the protecting communication routes sharing one or more paths so that the number of TSs used in the network is minimum. Thus, the efficient use of network resources becomes possible as described above.

Moreover, the second processing unit 101 uses, for example, the following equations (7) to (11) as constraint conditions.

$$\begin{matrix}{\sum }_{s ∈ S} {x}_{S}^{d} = {b}_{d} ( for ∀ d ∈ D ) & ( 7 ) \\ {\sum }_{h ∈ H} {x}_{h}^{d} = 1 ( for ∀ d ∈ D ) & ( 8 ) \\ {\sum }_{s ∈ S} {I}_{s}^{h} \cdot ( {x}_{s}^{d} - {x}_{h}^{d} ) \leq 0 ( for ∀ d ∈ D , ∀ h ∈ H ) & ( 9 ) \\ {\sum }_{d ∈ D} {I}_{f}^{d} \cdot {x}_{s}^{d} \leq 1 ( for ∀ s ∈ S , ∀ f ∈ F ) & ( 10 ) \\ {\sum }_{d ∈ D} ( {x}_{s}^{d} - {x}_{s} ) \leq 0 ( for ∀ s ∈ S ) & ( 11 )\end{matrix}$$

The equation (7) is a constraint condition (fourth constraint condition) for the number of TSs allocated to each of the protecting communication routes to match the bandwidth of the demand with respect to each of one or more paths. In FIG. 18, the bandwidth of the demand 1 is 2.5 (Gbps) and thus is accommodated by two TSs, while the bandwidths of the demands 2, 3 are 1.25 (Gbps), and thus each is accommodated by one TS.

The equation (8) and the equation (9) are constraint conditions (fifth constraint condition) for the number of the HO-ODUs used for each of the protecting communication routes to be one. In FIG. 18, TS1 and TS2 allocated to the protecting communication route 1 of the demand 1 belong to the same HO-ODU 1. That is to say, TSs of two different HO-ODUs are not permitted to be allocated to the working communication route or the protecting communication route of each demand.

The equation (10) is a constraint condition (sixth constraint condition) for the maximum number of the protecting communication routes using each TS to be one when a failure occurs in any one of the working communication routes. In FIG. 17 and FIG. 18, when the link failure 1 occurs, TS1 and TS2 of the HO-ODU 1 are used by only the protecting communication route 1 of the demand 1, and are not used by the protecting communication routes 2, 3 of other demands 2, 3. In addition, when the link failure 2 occurs, TS1 of the HO-ODU 1 is used by only the protecting communication route 2 of the demand 2, and TS2 of the HO-ODU 1 is used by only the protecting communication route 3 of the demand 3.

The equation (11) is a constraint condition on the equation for a variable xₛ to be 1 when each TS is used for the protecting communication route of at least one demand.

The second processing unit 101 obtains the solution satisfying the equation (6) according to the constraint conditions of the equations (7) to (11) to allocate TSs to each of the protecting communication routes sharing one or more paths. This effectively reduces the time required for the second designing process. The present embodiment uses the integer programming approach as an analyzing method, but does not intend to suggest any limitation, and may use other methods such as a heuristic method.

A description will next be given of application examples of the network design method described heretofore.

### Application Example 1

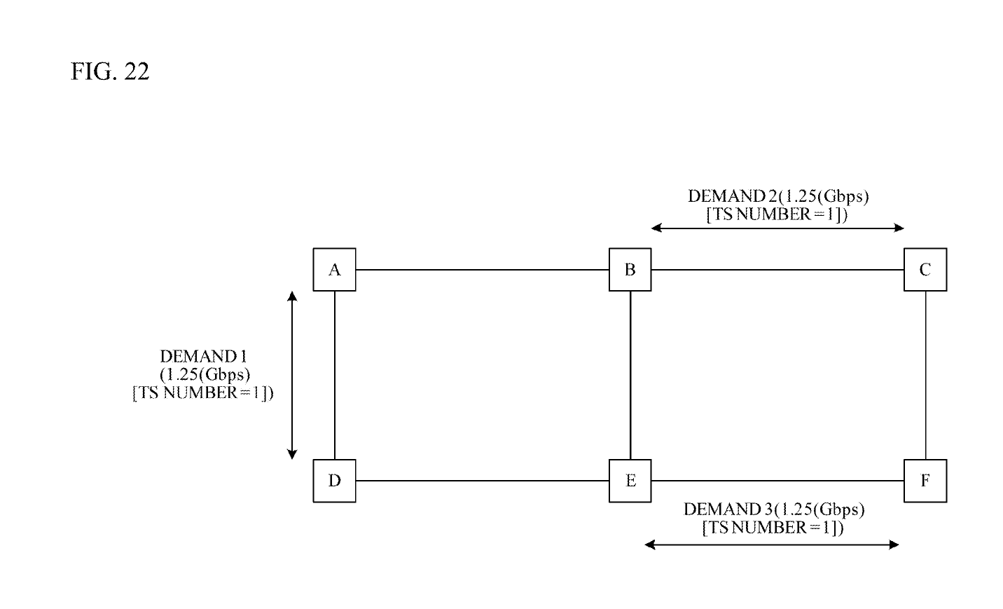

FIG. 22 illustrates demands to a network. The bandwidths of the demands 1 to 3 are 1.25 (Gbps) (TS number=1) used between the node A and the node D, between the node B and the node C, and between the node E and the node F. For convenience sake, assume that the path corresponds with the link between nodes. In addition, assume that “ODU2” (2.5 (Gbps)) (TS number=2) is used as a communication line used for each path.

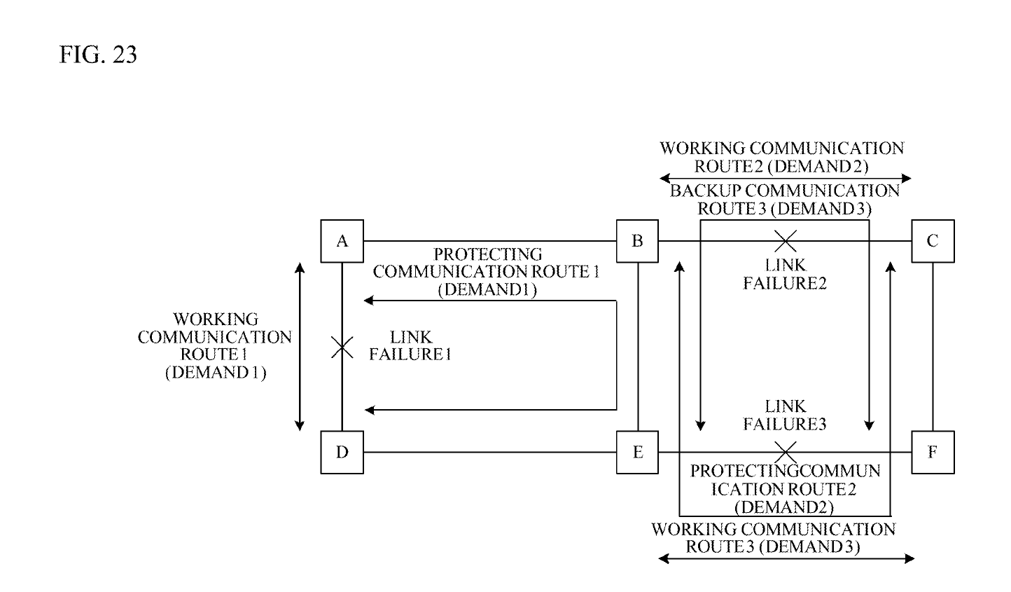

FIG. 23 illustrates working and protecting communication routes of the network illustrated in FIG. 22. The first processing unit 100 determines the working communication routes 1 to 3 and the protecting communication routes 1 to 3 for the demands 1 to 3. The working communication routes 1 to 3 are the path connecting the node A and the node D, the path connecting the node B and the node C, and the path connecting the node E and the node F, respectively.

The first processing unit 100 determines the protecting communication routes 1 to 3 while permitting the protecting communication routes 1 to 3 to share a path. The protecting communication route 1 is the path connecting the node A, the node B, the node E, and the node D, and the protecting communication route 2 is the path connecting the node B, the node E, the node F, and the node C. In addition, the protecting communication route 3 is the path connecting the node E, the node B, the node C, and the node F. Here, the path between the node B and the node E is shared by the protecting communication routes 1 to 3.

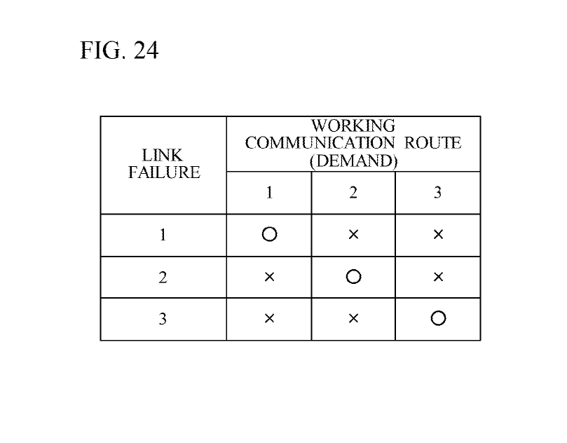

The first processing unit 100 estimates the bandwidths of and the number of the HO-ODUs established in each path in consideration of the bandwidths of the demands 1 to 3 and the shared bandwidth among the protecting communication routes 1 to 3. FIG. 24 illustrates the working communication routes in which a failure is caused by the link failures 1 to 3. In FIG. 24, circles indicate communication routes in which a failure is caused by a link failure, and crosses indicate communication routes in which a failure is not caused by a link failure.

The working communication routes 1 to 3 do not have overlapping paths, and thus the link failures 1 to 3 in respective communication routes cause a failure in only the respective communication routes. Therefore, the protecting communication routes 1 to 3 are not simultaneously used by switching of the communication route when a failure occurs in any one of the working communication routes 1 to 3. For example, when the link failure 1 occurs, a failure occurs in the working communication route 1, and thus the protecting communication route 1 is used and other protecting communication routes 2, 3 are not used. Therefore, the first processing unit 100 estimates the maximum value of the shared bandwidth to be used due to the link failures 1 to 3 to be 1.25 (Gbps) (TS number=1).

Therefore, one HO-ODU of 2.5 (Gbps) (“ODU2”) is determined for the HO-ODU established in the path between the node B and the node E shared by the protecting communication routes 1 to 3 as a result of estimation. In addition, regarding other path, one HO-ODU of 2.5 (Gbps) is determined according to the bandwidths of the demands 1 to 3.

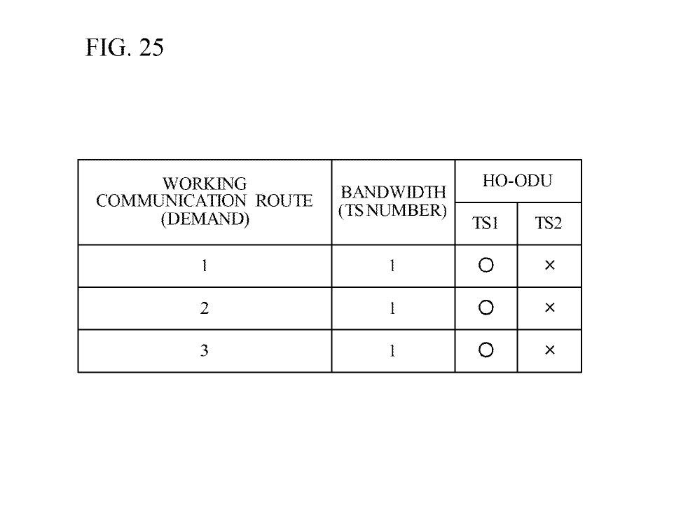

In addition, FIG. 25 illustrates allocation of TSs to the protecting communication routes illustrated in FIG. 23. In FIG. 25, circles indicate communication routes to which a TS is allocated, and crosses indicate communication routes to which a TS is not allocated.

The second processing unit 101 allocates TS1 of the HO-ODU to the protecting communication routes 1 to 3 based on the bandwidths of the demands 1 to 3 (1.25 (Gbps)) with respect to the shared path between the node B and the node E. That is to say, TS1 is shared by the protecting communication routes 1 to 3. In this case, the number of the HO-ODUs estimated by the first processing unit 100 is sufficient, and thus the second processing unit 101 does not add the HO-ODU (see step St24 in FIG. 14).

### Application Example 2

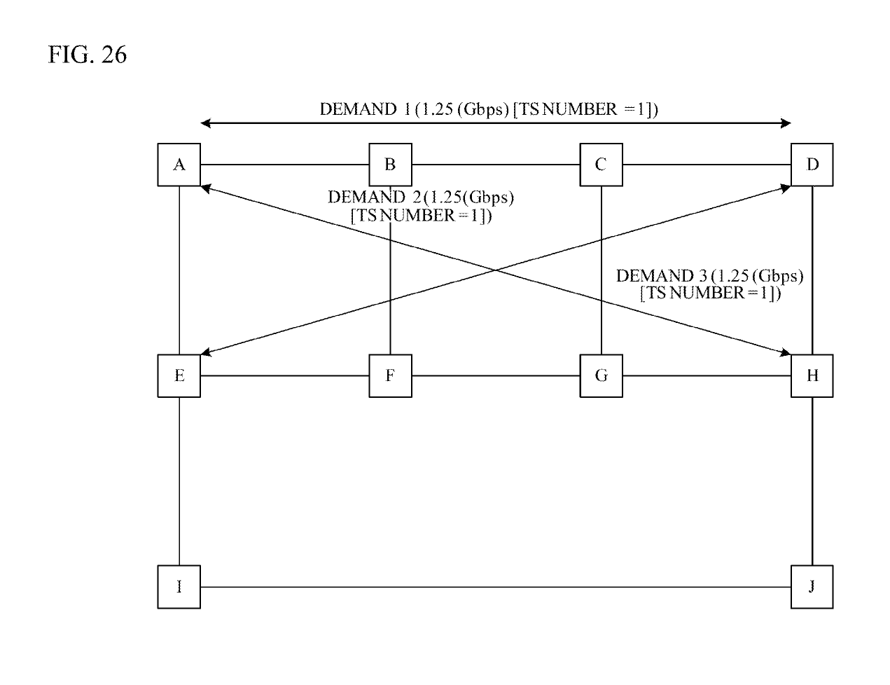

FIG. 26 illustrates alternative examples of demands to the network. The bandwidths of the demands 1 to 3 are 1.25 (Gbps) (TS number=1) used between the node A and the node D, between the node A and the node H, and between the node E and the node D. For convenience sake, assume that the path corresponds with the link.

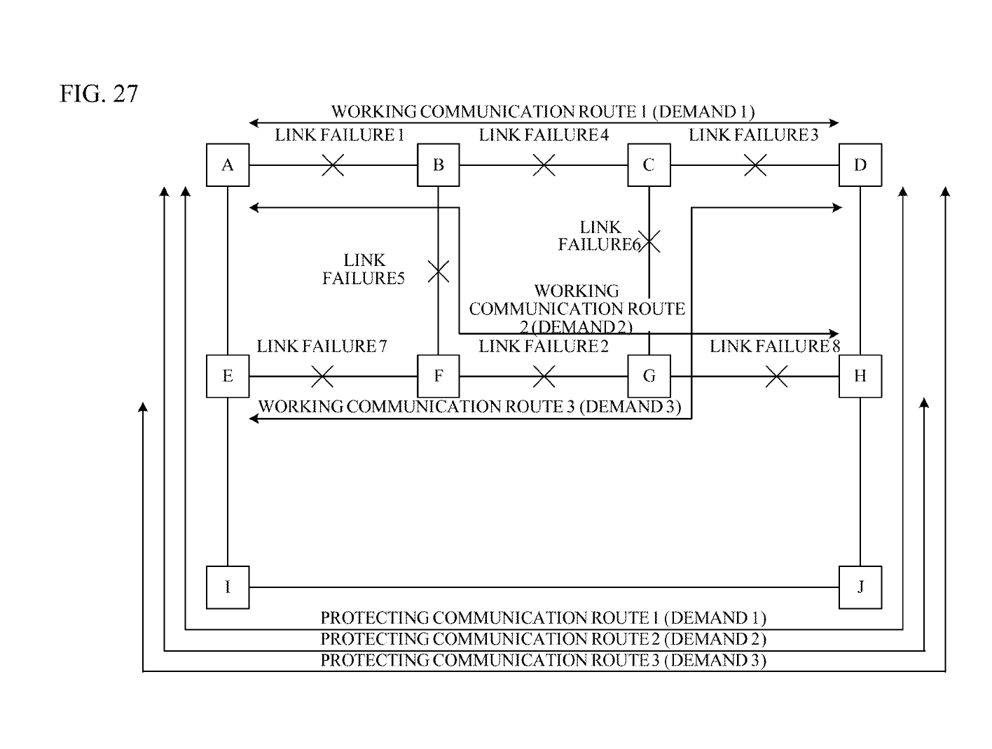

FIG. 27 illustrates working and protecting communication routes of the network illustrated in FIG. 26. The first processing unit 100 determines the working communication routes 1 to 3 and the protecting communication routes 1 to 3 corresponding to the demands 1 to 3. The working communication route 1 is the path connecting the node A, the node B, the node C, and the node D, and the working communication route 2 is the path connecting the node A, the node B, the node F, the node G, and the node H. Moreover, the working communication route 3 is the path connecting the node E, the node F, the node G, the node C, and the node D.

The first processing unit 100 determines the protecting communication routes 1 to 3 while permitting the protecting communication routes 1 to 3 to share a path. The protecting communication route 1 is the path connecting the node A, the node E, the node I, the node J, the node H, and the node D, and the protecting communication route 2 is the path connecting the node A, the node E, the node I, the node J, and the node H. The protecting communication route 3 is the path connecting the node E, the node I, the node J, the node H, and the node D. Here, the path between the node A and the node E is shared by the protecting communication routes 1, 2. Each of the paths between the nodes E and I, between the nodes I and J, and between the nodes J and H is shared by the protecting communication routes 1 to 3, and the path between the node H and the node D is shared by the protecting communication routes 1, 3.

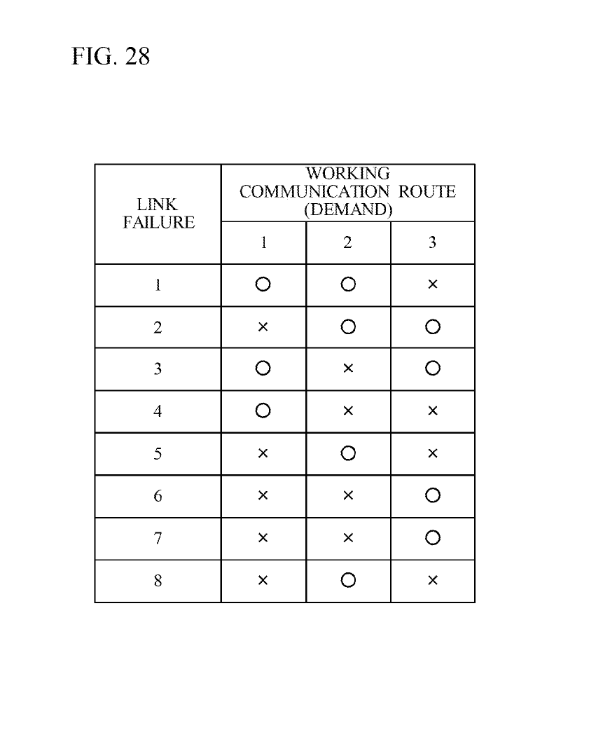

The first processing unit 100 estimates the bandwidths of and the number of the HO-ODUs established in each path in consideration of the bandwidths of the demands 1 to 3 and the shared bandwidth among the protecting communication routes 1 to 3. FIG. 28 illustrates the working communication routes in which a failure is caused by the link failures 1 to 8 illustrated in FIG. 27. In FIG. 28, circles indicate communication routes in which a failure is caused by a link failure, and crosses indicate communication routes in which a failure is not caused by a link failure.

The working communication routes 1, 2 have overlapping paths in the link between the node A and the node B. The working communication routes 2, 3 have overlapping paths in the link between the node F and the node G. The working communication routes 1, 3 have overlapping paths in the link between the node C and the node D.

Thus, the maximum number of the communication routes in which a failure is caused by the link failures 1 to 8 in the communication routes is two. In other words, two of the protecting communication routes 1 to 3 are simultaneously used when a failure occurs in any one of the working communication routes 1 to 3. Thus, the first processing unit 100 estimates the maximum value of the shared bandwidth to be used due to the link failures 1 to 8 to be 2.5 (Gbps) (TS number=2).

Therefore, one HO-ODU of 2.5 (Gbps) (“ODU2”) is determined for the HO-ODU established in each path shared among the protecting communication routes 1 to 3 as a result of estimation. In addition, regarding other paths, one HO-ODU of 2.5 (Gbps) is determined according to the bandwidths of the demands 1 to 3.

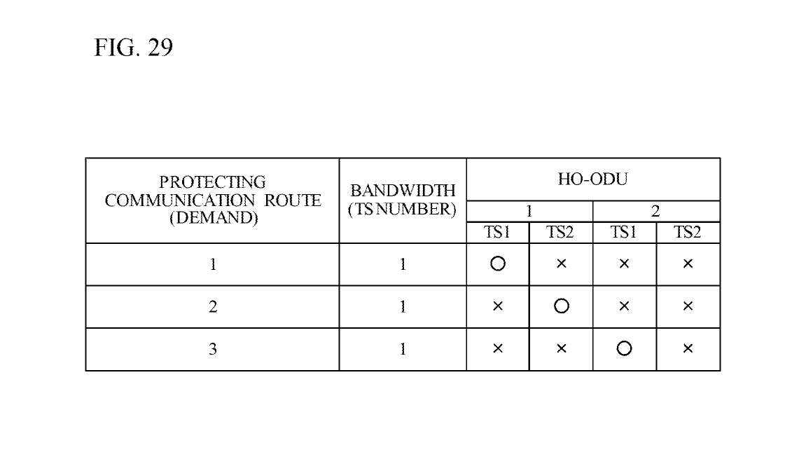

FIG. 29 illustrates allocation of TSs to the protecting communication routes (path between the node I and the node J) illustrated in FIG. 26. The second processing unit 101 statically allocates TSs to the protecting communication routes 1 to 3. That is to say, the TSs allocated to the protecting communication routes 1 to 3 are specific TSs and static.

If one HO-ODU is used in accordance with estimation by the first processing unit 100, TS 1 and TS2 of the HO-ODU 1 are respectively allocated to the protecting communication routes 1, 2. At this point, the remaining protecting communication route 3 needs to be dynamically allocated to one of TS1 and TS2 of the HO-ODU 1 in response to the link failures 1 to 8, and thus the TSs of one HO-ODU cannot be statically allocated. Therefore, the second processing unit 101 determines that the number of the HO-ODUs estimated by the first processing unit 100 is insufficient, and adds one HO-ODU (see step St24 in FIG. 14).

Therefore, the second processing unit 101 individually allocates TS1 and TS2 of two HO-ODUs 1, 2 to the protecting communication routes 1 to 3. As described above, the second processing unit 101 can perform the static allocation of TSs that is impossible in estimation in units of HO-ODUs by the first processing unit 100. That is to say, the second processing unit 101 has a function that complements an allocation process impossible by the first processing unit 100.

As described heretofore, the network design apparatus 1 of the embodiment includes the first processing unit 100 and the second processing unit 101. The first processing unit 100 selects one or more paths configured between nodes in a network in response to a request for bandwidths used for communications between pairs of nodes in the network to determine working communication routes and protecting communication routes connecting the pairs of nodes. Moreover, the first processing unit 100 estimates the number of HO-ODUs (communication lines) established in each of the selected one or more paths. On the other hand, the second processing unit 101 allocates TSs included in each of the HO-ODUs to the working communication routes and the protecting communication routes based on the requested bandwidths.

The first processing unit 100 determines the protecting communication routes while permitting the protecting communication routes to share one or more paths. The second processing unit 101 allocates a common TS out of the TSs to one or more communication routes out of the protecting communication routes, where the one or more communication routes share one or more paths and are not simultaneously used when a failure occurs in any one of the working communication routes.

The network design apparatus 1 of the embodiment allocates a common TS out of the TSs of the HO-ODU to the protecting communication routes, and thus enables to achieve the above described SMR method and efficient use of network resources. In addition, the network design apparatus 1 of the embodiment configures the first processing unit 100 to estimate the number of the HO-ODUs and the second processing unit 101 to allocate TSs, and thus can effectively reduce the time for designing by the two-stage designing process.

The network design method of the embodiment includes the first designing process executed by the first processing unit 100 (step St1 in FIG. 5) and the second designing process executed by the second processing unit 101 (step St2 in FIG. 5). The first designing process selects one or more paths configured between nodes in a network in response to a request for bandwidths used for communications between pairs of nodes in the network to determine working communication routes and protecting communication routes connecting the pairs of nodes. In addition, the first designing process estimates the number of HO-ODUs (communication lines) established in each of the selected one or more paths. On the other hand, the second designing process allocates TSs included in each HO-ODU to the working communication routes and the protecting communication routes based on the requested bandwidths.

The first designing process determines the protecting communication routes while permitting the protecting communication routes to share one or more paths. The second designing process allocates a common TS out of the TSs to one or more communication routes out of the protecting communication routes, where the one or more communication routes share one or more paths and are not simultaneously used when a failure occurs in any one of the working communication routes.

Therefore, the network design method of the embodiment has the same configurations as the network design apparatus 1, and thus has the same advantages.

In addition, the network design program of the embodiment includes the first designing process executed by the first processing unit 100 (step St1 in FIG. 5) and the second designing process executed by the second processing unit 101 (step St2 in FIG. 5). The first designing process selects one or more paths configured between nodes in a network in response to a request for bandwidths used for communications between pairs of nodes in the network to determine working communication routes and protecting communication routes connecting the pairs of nodes. In addition, the first designing process estimates the number of HO-ODUs (communication lines) established in each of the selected one or more paths. On the other hand, the second designing process allocates TSs included in each HO-ODU to the working communication routes and the protecting communication routes based on the requested bandwidths.

The first designing process determines the protecting communication routes while permitting the protecting communication routes to share one or more paths. The second designing process allocates a common TS out of the TSs to one or more communication routes out of the protecting communication routes, where the one or more communication routes share one or more paths, and are not simultaneously used when a failure occurs in any one of the working communication routes.

Therefore, the network design program of the embodiment has the same configurations as the network design apparatus 1, and thus has the same advantages.

In the embodiment described heretofore, the first processing unit 100 and the second processing unit 101 assume a single link failure as a failure pattern, but do not intend to suggest any limitation, and may execute the designing process assuming two or more link failures and one or more node failures.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

What is claimed is:

1. A network design apparatus comprising:
a first processing unit configured to select one or more paths in response to a request for a bandwidth to determine working communication routes and protecting communication routes connecting pairs of nodes in a network, and estimate a number of communication lines established in each of the one or more paths selected, the one or more paths being configured between nodes in the network, the bandwidth being to be used for communications between the pairs of nodes; and
a second processing unit configured to allocate logical channels to the working communication routes and the protecting communication routes based on the requested bandwidth, the logical channels being included in each of the communication lines, wherein
the first processing unit determines the protecting communication routes while permitting the protecting communication routes to share the one or more paths, and
the second processing unit allocates a common logical channel out of the logical channels to one or more communication routes out of the protecting communication routes, the one or more communication routes sharing the one or more paths and being not simultaneously used when a failure occurs in at least one of the working communication routes.

2. The network design apparatus according to claim 1, wherein
the first processing unit estimates the number of the communication lines with respect to each of bandwidths of the communication lines, and
each of the communication lines includes as many the logical channels as correspond to the bandwidths of the communication lines.

3. The network design apparatus according to claim 1, wherein
the second processing unit adds, when a number of the logical channels to be allocated to the working communication routes or the protecting communication routes is insufficient, the communication line to a corresponding path out of the one or more path and performs allocation again.

4. The network design apparatus according to claim 1, wherein
the first processing unit estimates the number of the communication lines so that entire cost of the communication lines in the network is minimum according to:
a first constraint condition for the working communication routes and the protecting communication routes to be respectively one working communication route and one protecting communication route selected from communication route candidates obtained by selection of the one or more paths;
a second constraint condition for a total bandwidth of the communication lines, with respect to each of the one or more paths, to be greater than or equal to a value that is obtained by adding a total bandwidth of communication routes including the path out of the working communication routes to a bandwidth shared by the protecting communication routes; and
a third constraint condition for a bandwidth shared by the protecting communication routes, with respect to each of the one or more paths, to be a total bandwidth of at least two communication routes out of the protecting communication routes, the at least two communication routes sharing the path and being simultaneously used when a failure occurs in at least one of the working communication routes.

5. The network design apparatus according to claim 1, wherein
the second processing unit allocates the logical channels to each of the protecting communication routes that share the one or more paths so that a number of the logical channels used in the network is minimum according to:
a fourth constraint condition for the number of the logical channels allocated to each of the protecting communication routes to be a number matching the requested bandwidth;
a fifth constraint condition for the number of the communication lines used for each of the protecting communication routes to be one; and
a sixth constraint condition for a maximum number of the protecting communication routes using each of the logical channels to be one when a failure occurs in at least one of the working communication routes.

6. A network design method executed by a computer, the network design method comprising:
selecting one or more paths in response to a request for a bandwidth to determine working communication routes and protecting communication routes connecting pairs of nodes in a network; the one or more paths being configured between nodes in the network, the bandwidth being to be used for communications between the pairs of nodes;
estimating the number of communication lines established in each of the one or more paths selected; and
allocating logical channels to the working communication routes and the protecting communication routes based on the requested bandwidth, the logical channels being included in each of the communication lines, wherein
the estimating of the number of the communication lines includes determining the protecting communication routes while permitting the protecting communication routes to share the one or more paths;
the allocating of the logical channels includes allocating a common logical channel out of the logical channels to one or more communication routes out of the protecting communication routes, the one or more communication routes sharing the one or more paths and being not simultaneously used when a failure occurs in at least one of the working communication routes.

7. The network design method according to claim 6, wherein
the estimating of the number of the communication lines includes estimating the number of the communication lines with respect to each of bandwidths of the communication lines, and
each of the communication lines includes as many the logical channels as correspond to the bandwidths of the communication lines.

8. The network design method according to claim 6, wherein
the allocating of the logical channels includes adding the communication line to a corresponding path out of the one or more paths and performing allocation again when a number of the logical channels to be allocated to the working communication routes or the protecting communication routes is insufficient.

9. The network design method according to claim 6, wherein
the estimating of the number of the communication lines includes estimating the number of the communication lines so that entire cost of the communication lines in the network is minimum according to:
a first constraint condition for the working communication routes and the protecting communication routes to be respectively one working communication route and one protecting communication route selected from communication route candidates obtained by selection of the one or more paths;
a second constraint condition for a total bandwidth of the communication lines, with respect to each of the one or more paths, to be greater than or equal to a value that is obtained by adding a total bandwidth of communication routes including the path out of the working communication routes to a bandwidth shared by the protecting communication routes; and
a third constraint condition for a bandwidth shared by the protecting communication routes, with respect to each of the one or more paths, to be a total bandwidth of at least two communication routes out of the protecting communication routes, the at least two communication routes sharing the path and being simultaneously used when a failure occurs in at least one of the working communication routes.

10. The network design method according to claim 6, wherein
the allocating of the logical channels includes allocating the logical channels to each of the protecting communication routes that share the one or more paths so that the number of the logical channels used in the network is minimum according to:
a fourth constraint condition for the number of the logical channels allocated to each of the protecting communication routes to be a number matching the requested bandwidth;
a fifth constraint condition for the number of the communication lines used for each of the protecting communication routes to be one; and
a sixth constraint condition for a maximum number of the protecting communication routes using each of the logical channels to be one when a failure occurs in at least one of the working communication routes.

11. A computer readable storage medium storing a network design program causing a computer to execute a process, the process comprising:
selecting one or more paths in response to a request for a bandwidth to determine working communication routes and protecting communication routes connecting pairs of nodes in a network; the one or more paths being configured between nodes in the network, the bandwidth being to be used for communications between the pairs of nodes;
estimating the number of communication lines established in each of the one or more paths selected; and
allocating logical channels to the working communication routes and the protecting communication routes based on the requested bandwidth, the logical channels being included in each of the communication lines, wherein
the estimating of the number of the communication lines includes determining the protecting communication routes while permitting the protecting communication routes to share the one or more paths;
the allocating of the logical channels includes allocating a common logical channel out of the logical channels to one or more communication routes out of the protecting communication routes, the one or more communication routes sharing the one or more paths and being not simultaneously used when a failure occurs in at least one of the working communication routes.

12. The computer readable storage medium according to claim 11, wherein
the estimating of the number of the communication lines includes estimating the number of the communication lines with respect to each of bandwidths of the communication lines, and
each of the communication lines includes as many the logical channels as correspond to the bandwidths of the communication lines.

13. The computer readable storage medium according to claim 11, wherein
the allocating of the logical channels includes adding the communication line to a corresponding path out of the one or more paths and performing allocation again when a number of the logical channels to be allocated to the working communication routes or the protecting communication routes is insufficient.

14. The computer readable storage medium according to claim 11, wherein
the estimating of the number of the communication lines includes estimating the number of the communication lines so that entire cost of the communication lines in the network is minimum according to:
a first constraint condition for the working communication routes and the protecting communication routes to be respectively one working communication route and one protecting communication route selected from communication route candidates obtained by selection of the one or more paths;
a second constraint condition for a total bandwidth of the communication lines, with respect to each of the one or more paths, to be greater than or equal to a value that is obtained by adding a total bandwidth of communication routes including the path out of the working communication routes to a bandwidth shared by the protecting communication routes; and
a third constraint condition for a bandwidth shared by the protecting communication routes, with respect to each of the one or more paths, to be a total bandwidth of at least two communication routes out of the protecting communication routes, the at least two communication routes sharing the path and being simultaneously used when a failure occurs in at least one of the working communication routes.

15. The computer readable storage medium according to claim 14, wherein
the allocating of the logical channels includes allocating the logical channels to each of the protecting communication routes that share the one or more paths so that the number of the logical channels used in the network is minimum according to:
a fourth constraint condition for the number of the logical channels allocated to each of the protecting communication routes to be a number matching the requested bandwidth;
a fifth constraint condition for the number of the communication lines used for each of the protecting communication routes to be one; and
a sixth constraint condition for a maximum number of the protecting communication routes using each of the logical channels to be one when a failure occurs in at least one of the working communication routes.
